(19) United States
(12) Patent Application Publication
(10) Pub. No.: US 2026/0024533 A1
(43) Pub. Date: Jan. 22, 2026

(54) Speech Synthesis Method and Systems

(71) Applicant: Tencent Technology (Shenzhen) Company Limited, Shenzhen (CN)

(72) Inventors: Shilun Lin, Shenzhen (CN); Li Meng, Shenzhen (CN); Wenchao Su, Shenzhen (CN)

(21) Appl. No.: 19/342,858

(22) Filed: Sep. 29, 2025

Related U.S. Application Data
(63) Continuation of application No. PCT/CN2024/113350, filed on Aug. 20, 2024.

(30) Foreign Application Priority Data
Oct. 25, 2023 (CN) 2023114035908

(51) Int. Cl. G10L 19/00; G10L 15/02; G10L 15/18; G10L 25/30

(52) U.S. Cl. CPC G10L 19/0018; G10L 15/02; G10L 15/1822; G10L 25/30

(57) ABSTRACT

Speech synthesis techniques are described herein, which relate to the field of artificial intelligence (AI). The techniques may include performing feature extraction on prompt audio to obtain a prompt semantic token and a prompt acoustic token; performing feature extraction on input text to obtain an input semantic token; acquiring an input acoustic token based on the prompt semantic token, the prompt acoustic token, and the input semantic token; and generating an output audio of the input text based on the input acoustic token. According to this application accuracy of speech synthesis can be improved.

### CROSS REFERENCE TO RELATED APPLICATIONS

This application is a Continuation of PCT Application No. PCT/CN2024/113350, filed Aug. 20, 2024, entitled “Speech Synthesis Method and Apparatus, Device, Storage Medium, and Program Product”, which claims priority to Chinese Patent Application No. 202311403590.8, filed on Oct. 25, 2023 and entitled “SPEECH SYNTHESIS METHOD AND APPARATUS, DEVICE, STORAGE MEDIUM, AND PROGRAM PRODUCT”, each of which is incorporated herein by reference in its entirety.

### FIELD

This application relates to the field of artificial intelligence (AI) technologies, and in particular, to a speech synthesis method and apparatus, a device, a storage medium, and a program product.

### BACKGROUND

Speech synthesis refers to a process of converting a text into an audio. In this process, speech synthesis is generally performed by using a speech synthesis system based on an AI model.

In a related technology, a speech synthesis system may input a text of speech content and a prompt audio into an acoustic token extraction model, to extract an acoustic token, and the acoustic token is taken as an acoustic feature of a to-be-generated audio and is inputted into a sound decoder, to generate a final audio. Speech content of the generated audio originates from the foregoing text, and features such as a timbre and an emotion of the audio are derived from the foregoing prompt audio.

In the foregoing solution, the acoustic token is directly predicted from the text and the prompt audio, and a feature span from the text to the acoustic token is excessively large, leading to a high requirement for labeled data during the training of the acoustic token extraction model, thereby limiting accuracy of the acoustic token extraction model and further affecting accuracy of speech synthesis.

### SUMMARY

Speech synthesis methods and systems are described herein, which can improve accuracy of speech synthesis.

According to an aspect as described herein, a speech synthesis method is provided, the method being performed by a computer device, and the method including:
acquiring an input text and a prompt audio;
performing feature extraction on the prompt audio to obtain a prompt semantic token and a prompt acoustic token, the prompt semantic token being configured for indicating semantic features of the prompt audio at respective time points, and the prompt acoustic token being configured for indicating acoustic features of the prompt audio at the time points;
performing feature extraction on the input text to obtain an input semantic token, the input semantic token being configured for indicating semantic features of a speech corresponding to the input text at the time points;
acquiring an input acoustic token based on the prompt semantic token, the prompt acoustic token, and the input semantic token, the input acoustic token being configured for indicating acoustic features of the speech corresponding to the input text at the time points; and
acquiring an output audio of the input text based on the input acoustic token.

According to an aspect as described herein, a speech synthesis apparatus is provided, the apparatus including:
an acquisition module, configured to acquire an input text and a prompt audio;
a first extraction module, configured to perform feature extraction on the prompt audio to obtain a prompt semantic token and a prompt acoustic token, the prompt semantic token being configured for indicating semantic features of the prompt audio at respective time points, and the prompt acoustic token being configured for indicating acoustic features of the prompt audio at the time points;
a second extraction module, configured to perform feature extraction on the input text to obtain an input semantic token, the input semantic token being configured for indicating semantic features of a speech corresponding to the input text at the time points;
an input acoustic token acquisition module, configured to acquire an input acoustic token based on the prompt semantic token, the prompt acoustic token, and the input semantic token, the input acoustic token being configured for indicating acoustic features of the speech corresponding to the input text at the time points; and
an output audio acquisition module, configured to acquire an output audio of the input text based on the input acoustic token.

In some aspects, the first extraction module is configured to input the prompt audio into a semantic token extractor to obtain the prompt semantic token obtained by the semantic token extractor by processing the prompt audio; and input the prompt audio into an acoustic token extractor to obtain the prompt acoustic token obtained by the acoustic token extractor by processing the prompt audio;
the second extraction module is configured to input the input text into a text-to-semantic token model to obtain the input semantic token obtained by the text-to-semantic token model by processing the input text;
the input acoustic token acquisition module is configured to input the prompt semantic token, the prompt acoustic token, and the input semantic token into a semantic token-to-acoustic token model, to obtain the input acoustic token outputted by the semantic token-to-acoustic token model; and
the output audio acquisition module is configured to input the input acoustic token into a sound decoder to obtain the output audio outputted by the sound decoder.

In some aspects, the semantic token extractor includes a convolution branch and a first transformer; and the first extraction module is configured to input the prompt audio into the convolution branch to obtain hidden-layer features, which are outputted by the convolution branch, of the prompt audio at the time points; process the hidden-layer features of the prompt audio at the time points by using the first transformer, to obtain intermediate-layer features, which are outputted by an intermediate layer of the first transformer, of the prompt audio at the time points; and cluster the intermediate-layer features of the prompt audio at the time points to obtain the prompt semantic token.

In some aspects, the apparatus further includes: a semantic token extractor training module, configured to acquire a first audio sample and a semantic token label of the first audio sample; input the first audio sample into the convolution branch to obtain hidden-layer feature samples, which are outputted by the convolution branch, of the first audio sample at the time points; partially mask the hidden-layer feature samples of the first audio sample at the time points to obtain partially masked hidden-layer feature samples; process the partially masked hidden-layer feature samples by using the first transformer, to obtain intermediate-layer features, which are outputted by the intermediate layer of the first transformer, of the first audio sample at the time points; cluster the intermediate-layer features of the first audio sample at the time points to obtain a semantic token sample of the first audio sample; and update a parameter of the semantic token extractor based on the semantic token sample of the first audio sample and the semantic token label of the first audio sample.

In some aspects, the text-to-semantic token model includes a text encoder, a duration predictor, an upsampling branch, and a decoder; and the second extraction module is configured to input the input text into the text encoder to obtain a hidden text encoding representation of the input text; input the hidden text encoding representation into the duration predictor to obtain a playback duration, which is predicted by the duration predictor, of the speech corresponding to the input text; upsample, by using the upsampling branch, the hidden text encoding representation to a quantity of frames corresponding to the playback duration, to obtain an upsampled hidden text encoding representation; and decode the upsampled hidden text encoding representation by using the decoder, to obtain the input semantic token.

In some aspects, the apparatus further includes: a text-to-semantic token model training module, configured to acquire a second audio sample and a speech text of the second audio sample when training of the semantic token extractor is completed; input the second audio sample into the semantic token extractor to obtain a semantic token label, which is outputted by the semantic token extractor, of the second audio sample; input the speech text of the second audio sample into the text-to-semantic token model to obtain a semantic token sample, which is outputted by the text-to-semantic token model, of the second audio sample; and update a parameter of the text-to-semantic token model based on the semantic token sample of the second audio sample and the semantic token label of the second audio sample.

In some aspects, the text-to-semantic token model training module is further configured to input the speech text of the second audio sample into the text encoder to obtain a hidden text encoding representation sample of the speech text of the second audio sample; input the hidden text encoding representation sample into the duration predictor to obtain a first playback duration sample, which is predicted by the duration predictor, of a speech corresponding to the speech text of the second audio sample; input the hidden text encoding representation sample into an attention branch to obtain a second playback duration sample, which is outputted by the attention branch, of the speech corresponding to the speech text of the second audio sample; upsample, by using the upsampling branch, the hidden text encoding representation sample to a quantity of frames corresponding to the second playback duration sample, to obtain an upsampled hidden text encoding representation sample; decode the upsampled hidden text encoding representation sample by using the decoder, to obtain the semantic token sample of the second audio sample; acquire a loss function value of the text-to-semantic token model based on the first playback duration sample, the second playback duration sample, the semantic token sample of the second audio sample, and the semantic token label of the second audio sample; and update the parameter of the text-to-semantic token model based on the loss function value of the text-to-semantic token model.

In some aspects, the text-to-semantic token model training module is configured to acquire a first loss function value of the text-to-semantic token model based on a difference between the first playback duration sample and the second playback duration sample; acquire a second loss function value of the text-to-semantic token model based on a difference between the semantic token sample of the second audio sample and the semantic token label of the second audio sample; and determine the loss function value of the text-to-semantic token model based on the first loss function value of the text-to-semantic token model and the second loss function value of the text-to-semantic token model.

In some aspects, the semantic token-to-acoustic token model includes a second transformer; and the input acoustic token acquisition module is configured to obtain a prefix by combination in order of the prompt semantic token, the input semantic token, and the prompt acoustic token; and predict, by using the second transformer in a self-recursive manner starting from the prefix, acoustic features of the speech corresponding to the input text at the time points, to obtain the input acoustic token.

In some aspects, orders of the prompt acoustic token and the input acoustic token are 2.

In some aspects, the apparatus further includes: a semantic token-to-acoustic token model training module, configured to acquire a third audio sample and a fourth audio sample when training of the semantic token extractor and the acoustic token extractor is completed; the third audio sample and the fourth audio sample being two non-overlapping audio segments in a same audio; separately extract a semantic token label of the third audio sample and a semantic token label of the fourth audio sample by using the semantic token extractor; separately extract an acoustic token label of the third audio sample and an acoustic token label of the fourth audio sample by using the acoustic token extractor; obtain a prefix sample by combination in order of the semantic token label of the third audio sample, the semantic token label of the fourth audio sample, and the acoustic token label of the third audio sample; predict, by using the second transformer, an acoustic token sample of the fourth audio sample in a self-recursive manner starting from the prefix sample; and update a parameter of the semantic token-to-acoustic token model based on the acoustic token sample of the fourth audio sample and the acoustic token label of the fourth audio sample.

According to another aspect as described herein, a computer device is provided, the computer device including a processor and a memory, the memory having at least one instruction stored therein, the at least one instruction being loaded and executed by the processor to implement the speech synthesis methods as described in the above aspects.

According to another aspect as described herein, a computer-readable storage medium is provided, the computer-readable storage medium having at least one instruction stored therein, and the at least one instruction being loaded and executed by a processor to implement the speech synthesis methods as described in the above aspects.

According to another aspect as described herein, a computer program product is provided, the computer program product including computer instructions, the computer instructions being stored in a computer-readable storage medium, and a processor reading the computer instructions from the computer-readable storage medium and executing the computer instructions, to implement the speech synthesis methods as described in the above aspects.

The technical solutions provided in the aspects as described herein may include the following beneficial effects:
Firstly, an input text and a prompt audio are acquired; next, feature extraction is performed on the prompt audio to obtain a prompt semantic token and a prompt acoustic token, and feature extraction is performed on the input text, to obtain an input semantic token; further, an input acoustic token is acquired based on the prompt semantic token, the prompt acoustic token, and the input semantic token; and finally, an output audio of the input text is acquired based on the input acoustic token, thereby implementing quick conversion from an acoustic token to an audio. According to the foregoing solution, a processing process of the input text and the prompt audio is divided into two stages. Firstly, a semantic token of the input text, a semantic token of the prompt audio, and an acoustic token of the prompt audio are obtained by using the input text and the prompt audio. Then, a final decoded acoustic token is predicted by using the semantic token of the input text, the semantic token of the prompt audio, and the acoustic token of the prompt audio. A semantic token extraction process is introduced as transition. This helps reduce a feature span of each process during prediction from the input text and the prompt audio to the final acoustic token, thereby improving accuracy of speech synthesis.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 is a schematic diagram of a computer system of a speech synthesis method according to an illustrative aspect as described herein.

FIG. 2 is a flowchart of a speech synthesis method according to an illustrative aspect as described herein.

FIG. 3 is a flowchart of a speech synthesis method according to an illustrative aspect as described herein.

FIG. 4 is a flowchart of implementation of a speech synthesis method according to an illustrative aspect as described herein.

FIG. 5 is a flowchart of a speech synthesis method according to an illustrative aspect as described herein.

FIG. 6 is a schematic diagram of a semantic token extractor according to an illustrative aspect as described herein.

FIG. 7 is a flowchart of a speech synthesis method according to an illustrative aspect as described herein.

FIG. 8 is a schematic diagram of a text-to-semantic token model according to an illustrative aspect as described herein.

FIG. 9 is a flowchart of a speech synthesis method according to an illustrative aspect as described herein.

FIG. 10 is a schematic diagram of a semantic token-to-acoustic token model according to an illustrative aspect as described herein.

FIG. 11 is an illustrative training and reasoning flowchart of a speech synthesis system according to this application.

FIG. 12 is a schematic diagram of an illustrative application scenario of a speech synthesis system according to this application.

FIG. 13 is a block diagram of a speech synthesis apparatus according to an illustrative aspect as described herein.

FIG. 14 is a structural block diagram of a computer device according to an illustrative aspect as described herein.

Accompanying drawings herein are incorporated into the specification and constitute a part of this specification, show aspects that conform to this application, and are used for describing principles as described herein together with this specification.

### DETAILED DESCRIPTION ASPECT

To make the objectives, technical solutions, and advantages as described herein clearer, the following further describes implementations as described herein in detail with reference to the accompanying drawings.

Illustrative aspects are described in detail herein, and examples thereof are shown in the accompanying drawings. When the following description involves the accompanying drawings, unless otherwise indicated, the same numerals in different accompanying drawings represent the same or similar elements. Implementations described in the following illustrative aspects do not represent all implementations consistent with this application. On the contrary, the implementations are merely examples of apparatuses and methods that are described in detail in the appended claims and are consistent with some aspects as described herein.

The terms used in the present disclosure are for the purpose of describing specific aspects only and are not intended to limit the present disclosure. The singular forms of “a/an” and “the” used in the present disclosure and the appended claims are intended to include the plural forms as well, unless the context clearly indicates otherwise. The term “and/or” used herein indicates and includes any or all possible combinations of one or more associated listed items.

User information (including, but not limited to, user equipment information, user personal information, and the like) and data (including, but not limited to, data for analysis, stored data, displayed data, and the like) as referred to as described herein are both information and data that are authorized by a user or fully authorized by all parties. Collection, use, and processing of related data need to comply with relevant laws and regulations of relevant countries and regions. For example, object behaviors such as attack operations as referred to as described herein are all acquired under full authorization.

Although the terms such as first and second may be used in the present disclosure to describe various information, the information is not limited to these terms. These terms are merely used to distinguish information of the same type. For example, a first parameter may be referred to as a second parameter, and similarly, the second parameter may also be referred to as the first parameter without departing from the scope of the present disclosure. Depending on the context, for example, the word “if” used herein may be interpreted as “while” or “when,” or “in response to determination.”

Some definitions of terms as referred to as described herein are described below.

Spectrograms are a representation manner of a time-domain signal in a frequency domain, and may be obtained by performing Fourier transform on a signal. Results obtained are two graphs whose vertical axis is amplitude and phase and horizontal axis is frequency. In application of a speech synthesis technology, phase information may often be omitted, and only amplitude information corresponding to different frequencies is reserved.

Fundamental frequency: In sound, a fundamental frequency is a frequency of a fundamental tone in a complex tone, denoted by a symbol FO. In a plurality of tones forming one complex tone, the fundamental tone has the lowest frequency and the highest intensity. A level of the fundamental frequency determines a pitch of a sound. The so-called frequency of speech usually refers to the frequency of the fundamental tone.

A vocoder is derived from an abbreviation of a voice encoder, and is also referred to as a speech signal analysis and synthesis system, with a function of converting an acoustic feature into a sound.

A hidden Markov model (HEMM) is a statistical analysis model and is configured to describe a Markov process including an implicit unknown parameter. In the HMM, a state is not directly visible, and some variables (observation values) affected by the state are visible.

A deep neural network (DNN) is a discriminative model, and is a multilayer perceptron (MLP) including more than two hidden layers. Except an input node, each node is a neuron with a non-linear activation function. Like the MLP, the DNN may be trained by using a back-propagation algorithm.

A convolutional neural network (CNN) is a feedforward neural network whose neurons may respond to units in a receptive field. The CNN usually includes a plurality of convolution layers and a fully-connected layer at the top, and reduces a parameter amount of the model by sharing parameters, so as to be widely used in image and speech recognition.

A recurrent neural network (RNN) is a recursive neural network in which sequence data is used as an input, recursion is performed in a sequence evolution direction, and all nodes (recurrent units) are connected in a chain manner.

A long short-term memory (LSTM) is a recurrent neural network, and adds a cell to an algorithm to determine whether information is useful. An input gate, a forget gate, and an output gate are placed in a cell. After the information enters the LSTM, whether the information is useful is determined according to a rule. Only information that is authenticated successfully by the algorithm may be retained, and information that fails to be authenticated by the algorithm is forgotten. The network is suitable for processing and predicting important events with relatively long intervals and delays in time sequences.

A gate recurrent unit (GRU) is an RNN. Like the LSTM, the GRU is also proposed to resolve problems such as gradients in long-term memory and back propagation. Compared with the LSTM, the GRU has one less “gate control” inside and fewer parameters than the LSTM. In most cases, the GRU can achieve the same effect as the LSTM and effectively reduce the calculation time.

A loss function is also referred to as a cost function, is a function configured for evaluating a degree of difference between a predicted value and a true value of a neural network model. A smaller function value of the loss function indicates better performance of the neural network model. A model training process is a process of minimizing the value of the loss function by adjusting a model parameter. For different neural network models, used loss functions are also different. Common loss functions include a 0-1 loss function, an absolute-value loss function, a logarithmic loss function, an exponential loss function, a perceptual loss function, a cross-entropy loss function, a Kullback-Leibler divergence loss function, a triplet loss function, and the like.

Speech synthesis is also referred to as text to speech (TTS), having a function of converting text information generated by a computer or inputted externally into a comprehensible and fluent speech and reading the speech out in an audible manner.

With the rapid development of intelligent devices (such as a smartphone and a smart speaker), a speech interaction technology, as a natural interaction manner, is increasingly used. As an important part of the speech interaction technology, a speech synthesis technology has also made great progress. In recent years, a large language model based on semi-supervised learning has achieved great success in natural language processing tasks.

In the semi-supervised learning, a large amount of unlabeled data is used for pre-training, and then a small amount of labeled data is used for fine-tuning or training of a particular module. The semi-supervised learning is between unsupervised learning (all training data is unlabeled) and supervised learning (all training data is labeled), which effectively alleviates the problem of limited labeled data in training data.

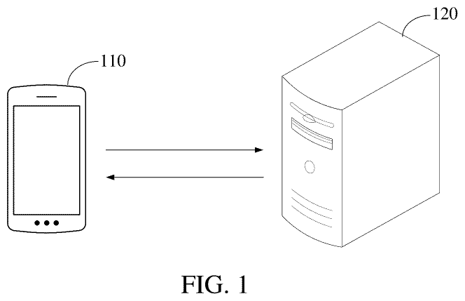

Refer to FIG. 1 which is a schematic diagram of a computer system of a speech synthesis method according to an illustrative aspect as described herein. The computer system may include: a terminal device 110 and a server 120.

The terminal device 110 is an electronic device providing a speech synthesis function.

The terminal device 110 includes, but is not limited to, a smartphone, a tablet computer, an intelligent voice interaction device, an intelligent household appliance, a vehicle-mounted terminal device, a laptop computer, a desktop computer, and the like.

A client providing a speech synthesis function may run in the terminal device 110. The client may be an instant messaging application program, a music playback application program, a reading application program, or the like. A specific type of the client is not limited in this aspect as described herein.

The server 120 may be a standalone physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network, and a big data and AI platform. In this aspect as described herein, the server is a backend server of the client providing the speech synthesis function in the terminal device 110, and may convert a text into a speech.

Data communication is performed between the terminal device 110 and the server 120 by using a communication network. In some aspects, the communication network may be a wired network or a wireless network, and the communication network is at least one of a local area network, a metropolitan area network, and a wide area network.

In the method provided in this aspect as described herein, operations may be performed by a computer device. The computer device may be any electronic device having data storage and processing capabilities. For example, the computer device may be the terminal device 110 or the server 120 in FIG. 1.

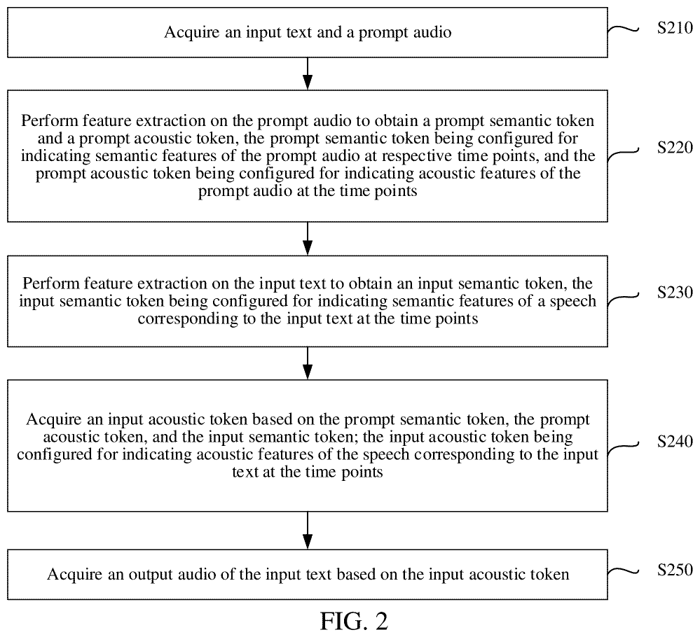

Refer to FIG. 2 which is a flowchart of a speech synthesis method according to an illustrative aspect as described herein. This method is performed by a computer device. In some aspects, the computer device may be the server 120 or the terminal device 110 in the system shown in FIG. 1, or the computer device may be another electronic device having a computing capability. As shown in FIG. 2, the method may include at least one of operation 210, operation 220, operation 230, operation 240, and operation 250 below.

Operation 210: Acquire an input text and a prompt audio.

In some aspects, the computer device acquires an input text and a prompt audio that are inputted by a terminal device. The input text includes text content of an output audio (or an output speech) that the terminal device intends to synthesize, and the prompt audio is an audio (or a speech) including sound information such as a timbre, a rhythm, and an emotion of a user of the terminal device.

For example, the output audio is a dubbed audio for a video, the input text is a complete dubbed text, and the prompt audio may be a 10-second dubbed segment.

In another example, the output audio is an 800-word poem recitation, the input text is a complete 800-word poem text, and the prompt audio may be a 5-second poem recitation with 15 words.

Operation 220: Perform feature extraction on the prompt audio to obtain a prompt semantic token and a prompt acoustic token, the prompt semantic token being configured for indicating semantic features of the prompt audio at respective time points, and the prompt acoustic token being configured for indicating acoustic features of the prompt audio at the time points.

In some aspects, the computer device performs, by using a pre-trained extraction model, feature extraction on the prompt audio acquired in operation 210, to acquire a prompt semantic token corresponding to the prompt audio.

The prompt semantic token is configured for indicating semantic features of the prompt audio at the time points.

In some aspects, the prompt semantic token may be configured for encoding a sequence number of a semantic unit corresponding to a text included in the prompt audio, and the semantic unit is the smallest semantic object in a semantic codebook.

Specifically, for example, after reasoning performed by the foregoing extraction model, a 1-second prompt audio is converted into 50 prompt semantic tokens.

In some aspects, the computer device performs, by using the pre-trained extraction model, feature extraction on the prompt audio acquired in operation 210, to acquire a prompt acoustic token.

The prompt acoustic token is configured for indicating acoustic features of the prompt audio at the time points. In some aspects, the time points are timestamps in the prompt audio. For example, a duration interval of the prompt audio is determined based on a length of the prompt audio. For example, a timestamp is set every threshold length in the duration interval, and the timestamps set in the duration interval are considered as the time points herein. For example, the threshold length is 1 s. For the following time points at other positions, refer to explanations and descriptions herein, and details are not described herein.

In some aspects, the prompt acoustic token may be configured for encoding a sequence number of a sound unit corresponding to a sound included in the prompt audio, and the sound unit is the smallest sound object in a sound codebook.

Specifically, for example, after reasoning performed by the foregoing extraction model, a 1-second 24-kHz prompt audio is converted into 2×75 prompt acoustic tokens.

Operation 230: Perform feature extraction on the input text to obtain an input semantic token, the input semantic token being configured for indicating semantic features of a speech corresponding to the input text at the time points.

In some aspects, the computer device acquires, by using the pre-trained extraction model, an input semantic token from the input text acquired in operation 210.

The input semantic token is configured for indicating semantic features of the speech corresponding to the input text at the time points.

In some aspects, the input semantic token may be configured for encoding a sequence number of a semantic unit corresponding to the input text, and the semantic unit is the smallest semantic object in the semantic codebook.

Specifically, for example, after reasoning performed by the foregoing extraction model, an input text with thousands of words is converted into tens of thousands of input semantic tokens.

Operation 240: Acquire an input acoustic token based on the prompt semantic token, the prompt acoustic token, and the input semantic token; the input acoustic token being configured for indicating acoustic features of the speech corresponding to the input text at the time points.

In some aspects, the computer device performs, by using a pre-trained conversion model, processing and reasoning on the prompt semantic token acquired in operation 220, the prompt acoustic token acquired in operation 220, and the input semantic token acquired in operation 230, to predict an input acoustic token.

The input acoustic token is configured for indicating acoustic features of the speech corresponding to the input text at the time points.

In some aspects, the input acoustic token may be configured for encoding a sequence number of a sound unit corresponding to the input text, and the sound unit is the smallest sound object in the sound codebook.

Operation 250: Acquire an output audio of the input text based on the input acoustic token.

In some aspects, when acquiring the output audio of the input text based on the input acoustic token, the computer device may decode, by using a pre-trained decoder, the input acoustic token acquired in operation 240, to convert the input acoustic token into the output audio corresponding to the input text.

Sound information such as a timbre, a rhythm, and an emotion in the output audio is from the prompt audio, and content of the speech in the output audio is from the input text.

In summary, in this aspect as described herein, the computer device first acquires an input text and a prompt audio; next, performs feature extraction on the prompt audio to obtain a prompt semantic token and a prompt acoustic token, and performs feature extraction on the input text, to obtain an input semantic token; further, acquires an input acoustic token based on the prompt semantic token, the prompt acoustic token, and the input semantic token; and finally, acquires an output audio of the input text based on the input acoustic token, thereby implementing quick conversion from an acoustic token to an audio. According to the foregoing solution, a processing process of the input text and the prompt audio is divided into two stages. Firstly, a semantic token of the input text, a semantic token of the prompt audio, and an acoustic token of the prompt audio are obtained by using the input text and the prompt audio. Then, a final decoded acoustic token is predicted by using the semantic token of the input text, the semantic token of the prompt audio, and the acoustic token of the prompt audio. A semantic token extraction process is introduced as transition. This helps reduce a feature span of each process during prediction from the input text and the prompt audio to the final acoustic token. Requirements of a model for a data volume and quality of labeled data are reduced, so that training can be performed by using a large amount of unlabeled data and a small amount of labeled data, thereby ensuring accuracy of the model and further improving accuracy of speech synthesis.

By use of the solution provided in this aspect as described herein, information such as semantics, a timbre, a rhythm, and an emotion in the prompt audio can be mined. In addition, based on transition of acquisition from a text to a semantic token, a one-to-many problem faced when an acoustic token is directly acquired from the text can be alleviated, thereby achieving an objective of zero-shot speech synthesis by using the prompt audio.

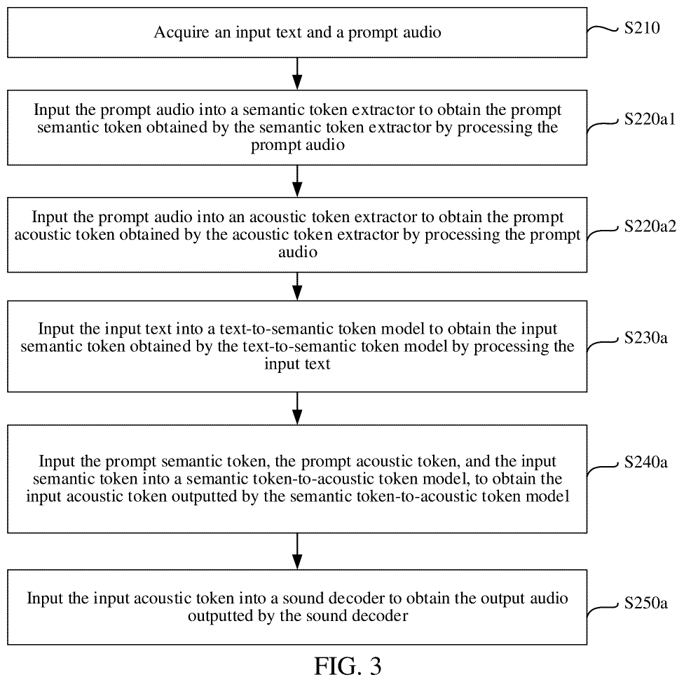

Based on the aspect shown in FIG. 2, refer to FIG. 3 which is a flowchart of a speech synthesis method according to an illustrative aspect as described herein. As shown in FIG. 3, operation 220 in the aspect shown in FIG. 2 may be implemented as at least one of operation 220a1 and operation 220a2, operation 230 may be implemented as operation 230a, operation 240 may be implemented as operation 240a, and operation 250 may be implemented as operation 250a.

Operation 220a1: Input the prompt audio into a semantic token extractor to obtain the prompt semantic token obtained by the semantic token extractor by processing the prompt audio.

The semantic token extractor may be a machine learning model pre-trained by using audio samples in an unsupervised learning manner, with a function of extracting, from an audio inputted, a semantic feature of speech content in the audio, to obtain a corresponding semantic token.

In some aspects, the semantic token extractor is a machine learning model configured to extract a semantic feature from an audio. For example, the semantic token extractor is a trained machine learning model configured to extract a semantic feature from an audio. In some aspects, the input to the semantic token extractor is the prompt audio, and the output is the prompt semantic token.

Operation 220a2: Input the prompt audio into an acoustic token extractor to obtain the prompt acoustic token obtained by the acoustic token extractor by processing the prompt audio.

The acoustic token extractor may be a machine learning model pre-trained by using audio samples in an unsupervised learning manner, with a function of extracting, from an audio inputted, an acoustic feature of the audio, to obtain a corresponding acoustic token. The acoustic feature may include features such as semantics, a timbre, an emotion, and a rhythm.

In some aspects, the acoustic token extractor is a machine learning model configured to extract an acoustic feature from an audio. For example, the acoustic token extractor is a trained machine learning model configured to extract an acoustic feature from an audio. In some aspects, the input to the acoustic token extractor is the prompt audio, and the output is the prompt acoustic token.

Operation 230a: Input the input text into a text-to-semantic token model to obtain the input semantic token obtained by the text-to-semantic token model by processing the input text.

The text-to-semantic token model may be a machine learning model trained in a supervised learning manner by using a trained semantic token extractor and labeled audio samples. A function of the text-to-semantic token model is to predict, from a text inputted, semantic features of a speech at respective time points after the text is converted into the speech, to obtain a corresponding semantic token.

In some aspects, the text-to-semantic token model is a machine learning model configured to extract a semantic feature from a text. For example, the text-to-semantic token model is a machine learning model configured to extract a semantic feature from a text. In some aspects, the input to the text-to-semantic token model is the input text, and the output is the input semantic token.

Operation 240a: Input the prompt semantic token, the prompt acoustic token, and the input semantic token into a semantic token-to-acoustic token model, to obtain the input acoustic token outputted by the semantic token-to-acoustic token model.

The semantic token-to-acoustic token model is a machine learning model trained in an unsupervised learning manner by using a semantic token extractor and an acoustic token extractor that are trained and audio samples, with a function of predicting, by using a semantic token and an acoustic token of a same audio and another semantic token, an acoustic token corresponding to the another semantic token.

In some aspects, the semantic token-to-acoustic token model is a machine learning model configured to convert a semantic feature into an acoustic feature. For example, the semantic token-to-acoustic token model is a trained machine learning model configured to convert a semantic feature into an acoustic feature. In some aspects, the input to the semantic token-to-acoustic token model is the prompt semantic token, the prompt acoustic token, and the input semantic token, and the output is the input acoustic token.

Operation 250a: Input the input acoustic token into a sound decoder to obtain the output audio outputted by the sound decoder.

The sound decoder may be a machine learning model trained in an unsupervised learning manner by a trained acoustic token extractor and unlabeled audio samples, with a function of decoding an acoustic token inputted, to generate an audio corresponding to the acoustic token.

In this aspect as described herein, the computer device acquires the prompt semantic token of the prompt audio by using the semantic token extractor, acquires the prompt acoustic token of the prompt audio by using the acoustic token extractor, and acquires the input semantic token of the input text by using the text-to-semantic token model; further, acquires, by using the semantic token-to-acoustic token model, the input acoustic token of the input text based on the prompt semantic token, the prompt acoustic token, and the input semantic token; and finally, performs sound conversion on the input acoustic token by using the sound decoder, to obtain the output audio corresponding to the input text, which implements quick conversion from an acoustic token to an audio, thereby providing a solution in which two-stage conversion from an input text and a prompt audio to a semantic token and then to an acoustic token is implemented by using a machine learning model. By using the foregoing solution, information such as semantics, a timbre, a rhythm, and an emotion in the prompt audio can be mined by using the semantic token extractor, the acoustic token extractor, and the text-to-semantic token model. In addition, predicting a semantic token by using a text can alleviate a one-to-many problem faced when an acoustic token is directly predicted from the text, thereby achieving an objective of zero-shot speech synthesis by using the prompt audio.

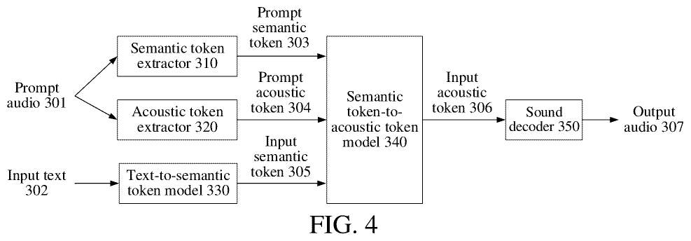

Refer to FIG. 4 which is a flowchart of implementation of a speech synthesis method according to an illustrative aspect as described herein. As shown in FIG. 4, a specific procedure is as follows:

After acquiring a prompt audio 301, the computer device inputs the prompt audio 301 into a semantic token extractor 310, and after performing reasoning on the prompt audio 301, the semantic token extractor 310 outputs a prompt semantic token 303 corresponding to the prompt audio 301.

After acquiring the prompt audio 301, the computer device inputs the prompt audio 301 into an acoustic token extractor 320, and after performing reasoning on the prompt audio 301, the acoustic token extractor 320 outputs a prompt acoustic token 304 corresponding to the prompt audio 301.

After acquiring an input text 302, the computer device inputs the input text 302 into a text-to-semantic token model 330, and after performing reasoning on the input text 302, the text-to-semantic token model 330 outputs an input semantic token 305 corresponding to the input text 302.

The computer device inputs the prompt semantic token 303, the prompt acoustic token 304, and the input semantic token 305 that are obtained to a semantic token-to-acoustic token model 340. After performing reasoning on the prompt semantic token 303, the prompt acoustic token 304, and the input semantic token 305, the semantic token-to-acoustic token model 340 outputs an input acoustic token 306 corresponding to the input text 302.

The computer device inputs the obtained input acoustic token 306 into a sound decoder 350. After performing reasoning on the input acoustic token 306, the sound decoder 350 outputs an output audio 307 corresponding to the input text 302.

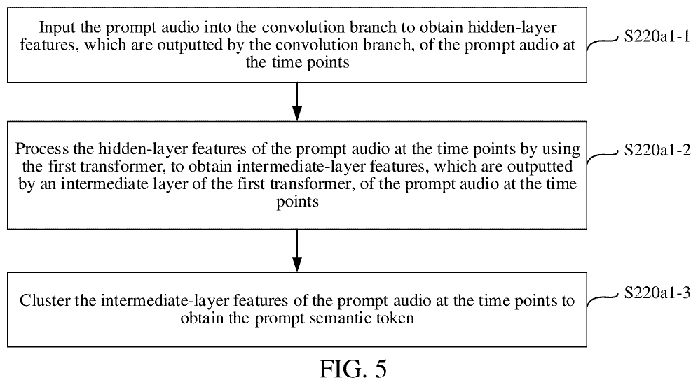

Based on the aspect shown in FIG. 3, refer to FIG. 5 which is a flowchart of a speech synthesis method according to an illustrative aspect as described herein. As shown in FIG. 5, the semantic token extractor includes a convolution branch and a first transformer. Operation 220a1 in the aspect shown in FIG. 3 may be implemented as at least one of operation 220a1-1, operation 220a1-2, and operation 220a1-3.

Operation 220a1-1: Input the prompt audio into the convolution branch to obtain hidden-layer features, which are outputted by the convolution branch, of the prompt audio at the time points.

In some aspects, the convolution branch is a neural network layer configured to implement a convolution operation. For example, the convolution branch includes at least one convolution layer. For example, different convolution layers correspond to different convolution kernels. For example, the at least one convolution layer implements a convolution process of first upsampling and then downsampling an input feature.

In this aspect as described herein, for the prompt audio, the semantic token extractor may perform feature extraction thereon by using the convolution layer, to obtain hidden-layer features at the time points.

Operation 220a1-2: Process the hidden-layer features of the prompt audio at the time points by using the first transformer, to obtain intermediate-layer features, which are outputted by an intermediate layer of the first transformer, of the prompt audio at the time points.

In this aspect as described herein, the intermediate-layer features, which are outputted by the intermediate layer of the first transformer, of the prompt audio at the time points may be features outputted by a layer specified in the first transformer.

Alternatively, the intermediate-layer features may be replaced with features finally outputted by the first transformer.

In some aspects, the first transformer is a neural network model configured to implement a conversion function, and the neural network model includes a plurality of neural network layers. In some aspects, the first transformer may be a transformer network. In some aspects, the intermediate layer of the first transformer refers to an output of any neural network layer included in the transformer network. Certainly, the first transformer may alternatively be another neural network other than the transformer network, including, but not limited to, at least one of a bert network and a U-net network. In some aspects, the intermediate layer of the first transformer may be specified in advance. In some aspects, a target neural network layer in the plurality of neural network layers in the transformer network may be specified in advance as an intermediate layer of the transformer network. In some aspects, the first transformer and the following second transformer are the same or different transformers.

Operation 220a1-3: Cluster the intermediate-layer features of the prompt audio at the time points to obtain the prompt semantic token.

In this aspect as described herein, for the intermediate-layer features outputted by the first transformer, for the intermediate-layer feature at each time point, a semantic category to which the intermediate-layer feature corresponding to the time point belongs is determined by feature clustering, to determine a semantic token corresponding to the time point, to obtain the prompt semantic token.

The foregoing solution provides a solution of extracting a semantic token by clustering after feature extraction is performed on an audio, thereby ensuring implementability of semantic token extraction by using a model.

In some aspects, the above method further includes:
acquiring a first audio sample and a semantic token label of the first audio sample. In some aspects, the semantic token label of the first audio sample is extracted by using a pre-trained semantic token extractor. For example, the semantic token label of the first audio sample is obtained by clustering Mel-frequency cepstral coefficients (MFCCs) of the first audio sample.

For example, the first audio sample is an audio acquired, and the audio is taken as a sample to obtain the first audio sample.

The first audio sample is inputted into the convolution branch to obtain hidden-layer feature samples, which are outputted by the convolution branch, of the first audio sample at the time points.

The hidden-layer feature samples of the first audio sample at the time points are partially masked to obtain partially masked hidden-layer feature samples.

For example, partial masking processing may also be considered as partial masking. For example, the hidden-layer feature samples of the first audio sample at the time points are partially masked, to improve diversity of the hidden-layer feature samples, thereby improving a model training effect.

The partially masked hidden-layer feature samples are processed by using the first transformer, to obtain intermediate-layer features, which are outputted by the intermediate layer of the first transformer, of the first audio sample at the time points.

The intermediate-layer features of the first audio sample at the time points are clustered to obtain a semantic token sample of the first audio sample.

A parameter of the semantic token extractor is updated based on the semantic token sample of the first audio sample and the semantic token label of the first audio sample.

In some aspects, a loss function value of the semantic token extractor is acquired based on the semantic token sample of the first audio sample and the semantic token label of the first audio sample; and the semantic token label of the first audio sample is obtained by clustering MFCCs of the first audio sample.

In some aspects, the loss function value of the semantic token extractor is determined based on a difference between the semantic token sample of the first audio sample and the semantic token label of the first audio sample.

The parameter of the semantic token extractor is updated based on the loss function value of the semantic token extractor.

For example, the parameter of the semantic token extractor is updated with a goal of minimizing the loss function value. A specific type of the loss function is not limited as described herein. For example, the loss function is a cross-entropy loss, a 0-1 loss function, an absolute-value loss function, a logarithmic loss function, an exponential loss function, a perceptual loss function, or the like. For example, parameters of the modules in the semantic token extractor are updated with a goal of minimizing the loss function value. For example, a parameter of a target module in the modules in the semantic token extractor is updated with a goal of minimizing the loss function value. For example, the target module is the convolution branch or the first transformer. For example, the parameter of the first transformer is kept unchanged, and only the parameter of the convolution branch is updated. In this manner, training costs can be reduced, and training efficiency can be improved.

In this aspect as described herein, when training the semantic token extractor, the computer device may extract MFCCs of the first audio sample, and then determine the semantic token label of the first audio sample by clustering the MFCCs of the first audio sample. The hidden-layer feature samples outputted by the convolution branch are partially masked, and after partially masked hidden-layer feature samples are predicted by using the first transformer, a loss is calculated with the semantic token label of the first audio sample. In this manner, the convolution branch and the first transformer are trained in terms of a semantic feature extraction capability, thereby providing a solution in which unsupervised learning is performed on the semantic token extractor by using unlabeled audios, without a need to rely on labeled data, thereby reducing a requirement for training data and ensuring accuracy of the model.

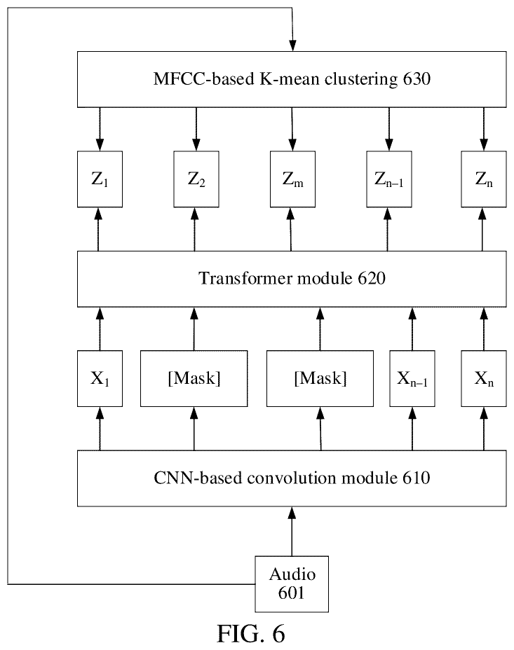

Refer to FIG. 6 which is a schematic diagram of a semantic token extractor according to an illustrative aspect as described herein. As shown in FIG. 6, the semantic token extractor includes a CNN-based convolution module 610 and a transformer module 620.

The convolution module 610 downsamples an inputted audio 601, to output Xₙ hidden-layer representations. The transformer module 620 predicts the Xₙ hidden-layer representations to obtain Zₙ predicted labels.

For example, the convolution module 610 converts a one-second audio into 50 frames of hidden-layer representations with a dimensionality of D. The transformer module 620 predicts the 50 frames of hidden-layer representations inputted, to obtain 50 predicted labels.

When the semantic token extractor is trained, a large amount of unlabeled data may be used for training. An original audio 601 is used as an input to the convolution module 610. After the convolution module 610 processes the inputted audio 601, an output of the convolution module 610 is randomly masked and then inputted into the transformer module 620. The transformer module 620 is required to be capable of predicting a label of a missing part according to a context when the input is missing, so as to enhance a context capturing capability of the model. Unsupervised K-mean clustering 630 may be performed after MFCCs are extracted from the original audio 601, a corresponding label is obtained to construct a loss function with predicted labels, and the parameter of the semantic token extractor is updated.

When a semantic token is extracted by reasoning by using the semantic token extractor, the audio 601 is inputted, is downsampled by the convolution module 610, and is directly inputted into the transformer module 620, intermediate-layer features of the transformer module 620 are acquired for clustering, and a category obtained by clustering each frame is used as a semantic token of the frame.

For example, a one-second audio passes through the convolution module 610 and then is converted into 50 frames of hidden-layer representations which are inputted into the transformer module 620, and an output (also 50 frames) of an Lth layer is taken for K-mean clustering 630. If a clustering result of the first frame belongs to a third category, the semantic token of the frame is 3. In conclusion, the one-second audio may be converted into 50 semantic tokens.

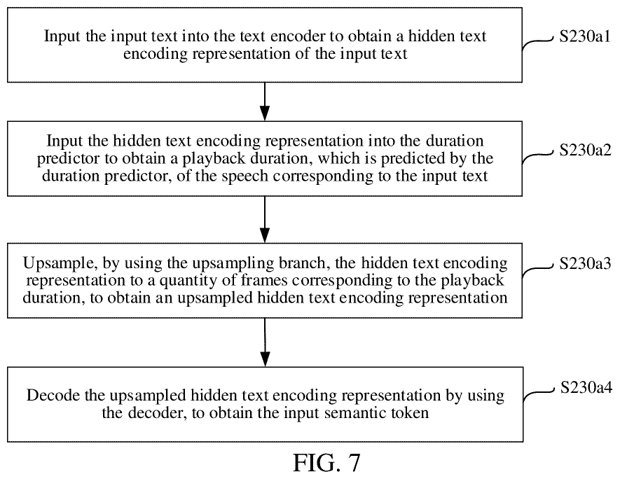

Based on the aspect shown in FIG. 3 or FIG. 5, refer to FIG. 7 which is a flowchart of a speech synthesis method according to an illustrative aspect as described herein. As shown in FIG. 7, the text-to-semantic token model includes a text encoder, a duration predictor, an upsampling branch, and a decoder. Operation 230a in the aspect shown in FIG. 3 may be implemented as operation 230a1, operation 230a2, operation 230a3, and operation 230a4.

Operation 230a1: Input the input text into the text encoder to obtain a hidden text encoding representation of the input text.

In this aspect as described herein, the text-to-semantic token model first encodes the input text by using a text encoder, to obtain a hidden text encoding representation. The hidden text encoding representation may be a feature vector or a feature matrix of the input text.

In some aspects, the text encoder is a neural network model (or neural network unit) configured to encode a text. In some aspects, the text encoder is a trained neural network model (or neural network unit) configured to encode a text.

Operation 230a2: Input the hidden text encoding representation into the duration predictor to obtain a playback duration, which is predicted by the duration predictor, of the speech corresponding to the input text.

In this aspect as described herein, the text-to-semantic token model processes the hidden text encoding representation by using the duration predictor, to predict a playback duration of a speech obtained from conversion of the input text, so as to subsequently determine a length/quantity of to-be-predicted semantic tokens according to the predicted playback duration.

In some aspects, the duration predictor is a neural network model (or neural network unit) configured to predict a duration. In some aspects, the duration predictor is a trained neural network model (or neural network unit) configured to predict a duration.

Operation 230a3: Upsample, by using the upsampling branch, the hidden text encoding representation to a quantity of frames corresponding to the playback duration, to obtain an upsampled hidden text encoding representation.

In some aspects, the upsampling branch is a neural network model (or neural network unit) configured for encoding. In some aspects, the upsampling branch is a trained neural network model (or neural network unit) configured for encoding.

In this aspect as described herein, after predicting the playback duration of the speech corresponding to the input text, the text-to-semantic token model upsamples the hidden text encoding representation by using the upsampling branch, so that a quantity of frames corresponding to the hidden text encoding representation is aligned with the playback duration of the speech corresponding to the input text, and a quantity of semantic tokens matching the playback duration of the speech corresponding to the input text can be predicted subsequently by using the upsampled hidden text encoding representation.

Operation 230a4: Decode the upsampled hidden text encoding representation by using the decoder, to obtain the input semantic token.

In this aspect as described herein, after obtaining the upsampled hidden text encoding representation, the text-to-semantic token model decodes the upsampled hidden text encoding representation by using the decoder, to obtain a quantity of input semantic tokens matching the playback duration of the speech corresponding to the input text.

In some aspects, the decoder is a neural network model (or neural network unit) configured for decoding. In some aspects, the decoder is a trained neural network model (or neural network unit) configured for decoding.

In the solution shown in the foregoing aspect as described herein, a representation of a text is converted into a series of semantic tokens by sequential processing of the text encoder, the duration predictor, the upsampling branch, and the decoder. The quantity of semantic tokens is aligned with the playback duration of the speech obtained from conversion of the input text, so as to ensure that the input semantic token can subsequently match a length of a to-be-generated audio, thereby ensuring accuracy of the semantic tokens extracted from the text.

In some aspects, the above method further includes:
acquiring a second audio sample and a speech text of the second audio sample when training of the semantic token extractor is completed; inputting the second audio sample into the semantic token extractor to obtain a semantic token label, which is outputted by the semantic token extractor, of the second audio sample; where the semantic token label is a semantic token extracted from the second audio sample;
inputting the speech text of the second audio sample into the text-to-semantic token model to obtain a semantic token sample, which is outputted by the text-to-semantic token model, of the second audio sample; and
updating a parameter of the text-to-semantic token model based on the semantic token sample of the second audio sample and the semantic token label of the second audio sample.

For example, a loss function value is determined based on a difference between the semantic token sample of the second audio sample and the semantic token label of the second audio sample. The parameter of the text-to-semantic token model is updated with a goal of minimizing the loss function value. A specific type of the loss function is not limited as described herein. For example, the loss function is a cross-entropy loss, a 0-1 loss function, an absolute-value loss function, a logarithmic loss function, an exponential loss function, a perceptual loss function, or the like. For example, parameters of the modules in the text-to-semantic token model are updated with a goal of minimizing the loss function value. For example, a parameter of a target module in the modules in the text-to-semantic token model is updated with a goal of minimizing the loss function value. For example, the target module is at least one of the text encoder, the duration predictor, the upsampling branch, and the decoder. For example, the parameters of the text encoder and the decoder are kept unchanged, and only parameters of the duration predictor and the upsampling branch are updated. In this manner, training costs can be reduced, and training efficiency can be improved.

In this aspect as described herein, for the text-to-semantic token model, training is performed in a supervised learning manner by using a trained semantic token extractor and a text-labeled audio (that is, the second audio sample corresponding to the speech text, where the speech text is a labeled text, and the speech text may be manually pre-labeled and determined), thereby ensuring accuracy of the text-to-semantic token model. In the foregoing supervised learning, semantic tokens used as labels are extracted from the text-labeled audio by the semantic token extractor.

In some aspects, the process of inputting the speech text of the second audio sample into the text-to-semantic token model to obtain a semantic token sample, which is outputted by the text-to-semantic token model, of the second audio sample may be the same as operation 230a1 to operation 230a4 above. Details are not described herein again.

In some aspects, the inputting the speech text of the second audio sample into the text-to-semantic token model to obtain a semantic token sample, which is outputted by the text-to-semantic token model, of the second audio sample includes:
inputting the speech text of the second audio sample into the text encoder to obtain a hidden text encoding representation sample of the speech text of the second audio sample;
inputting the hidden text encoding representation sample into the duration predictor to obtain a first playback duration sample, which is predicted by the duration predictor, of a speech corresponding to the speech text of the second audio sample;
inputting the hidden text encoding representation sample into an attention branch to obtain a second playback duration sample, which is outputted by the attention branch, of the speech corresponding to the speech text of the second audio sample;
upsampling, by using the upsampling branch, the hidden text encoding representation sample to a quantity of frames corresponding to the second playback duration sample, to obtain an upsampled hidden text encoding representation sample; and
decoding the upsampled hidden text encoding representation sample by using the decoder, to obtain the semantic token sample of the second audio sample; and
the updating a parameter of the text-to-semantic token model based on the semantic token sample of the second audio sample and the semantic token label of the second audio sample includes:
acquiring a loss function value of the text-to-semantic token model based on the first playback duration sample, the second playback duration sample, the semantic token sample of the second audio sample, and the semantic token label of the second audio sample.

In some aspects, during the training, an auxiliary learning network module, that is, the foregoing attention branch, may be introduced into the text-to-semantic token model, and the prediction of the playback duration is assisted by using the attention branch. Specifically, during the training, after the speech text of the second audio sample is inputted into the text encoder to obtain the hidden text encoding representation sample of the speech text of the second audio sample, the hidden text encoding representation sample is inputted into the duration predictor to obtain the first playback duration sample predicted by the duration predictor. In addition, the hidden text encoding representation sample is further inputted into the attention branch, and the second playback duration sample is predicted by using an attention prediction branch. Subsequently, after the second playback duration sample and the hidden text encoding representation sample are inputted into the upsampling branch for upsampling, a semantic token sample of the second audio sample is predicted by the decoder. Subsequently, the first playback duration sample, the second playback duration sample, the semantic token sample of the second audio sample, and the semantic token label of the second audio sample are used for calculation during calculation of the loss function, thereby extending an available loss and improving accuracy of model training.

In some aspects, the acquiring a loss function value of the text-to-semantic token model based on the first playback duration sample, the second playback duration sample, the semantic token sample of the second audio sample, and the semantic token label of the second audio sample includes:
acquiring a first loss function value of the text-to-semantic token model based on a difference between the first playback duration sample and the second playback duration sample;
acquiring a second loss function value of the text-to-semantic token model based on a difference between the semantic token sample of the second audio sample and the semantic token label of the second audio sample; and
determining the loss function value of the text-to-semantic token model based on the first loss function value of the text-to-semantic token model and the second loss function value of the text-to-semantic token model.

For example, a sum of the first loss function value and the second loss function value is directly taken as the loss function value of the text-to-semantic token model. For example, a weighted sum of the first loss function value of the text-to-semantic token model and the second loss function value of the text-to-semantic token model is calculated to obtain the loss function value of the text-to-semantic token model. For example, weights of the first loss function value and the second loss function value may be preset.

For example, when calculating the loss function value of the text-to-semantic token model, the computer device may calculate a difference between the first playback duration sample and the second playback duration sample by using a preset loss function, to obtain the first loss function value.

Similarly, the computer device may calculate a difference between the semantic token sample of the second audio sample and the semantic token label of the second audio sample by using the preset loss function, to obtain the second loss function value.

The first loss function value may be configured for updating a parameter of the duration predictor, or may be configured for updating parameters of the duration predictor and the text encoder. The second loss function value may be configured for updating parameters of the text encoder, the attention branch, the upsampling branch, and the decoder.

During model training, the computer device may update the text encoder, the attention branch, the upsampling branch, and the decoder by using the difference between the semantic token sample of the second audio sample and the semantic token label of the second audio sample, so that accuracy of the attention branch can be gradually increased along with the training process. In addition, the second playback duration sample outputted by using the attention branch is taken as a label for training the duration predictor. A difference between the second playback duration sample and a second playback duration sample outputted by the duration predictor is calculated, to update the parameter of the duration predictor or the parameters of the duration predictor and the text encoder. A prediction capability of the duration predictor approximates that of the attention branch, so that the first playback duration sample, the second playback duration sample, the semantic token sample of the second audio sample, and the semantic token label of the second audio sample are simultaneously used for calculation, thereby extending an available loss and improving accuracy of model training.

In addition, network complexity of the duration predictor may be lower than that of the attention branch. To be specific, during model training, duration prediction is performed by using an attention branch with relatively high complexity, to ensure accuracy of duration prediction. At the same time, by using the first loss function, the duration predictor can learn a prediction capability of the attention branch with relatively high complexity, to ensure accuracy of the duration predictor. In addition, since the network complexity of the duration predictor is relatively low, efficiency of duration prediction can be improved during subsequent reasoning.

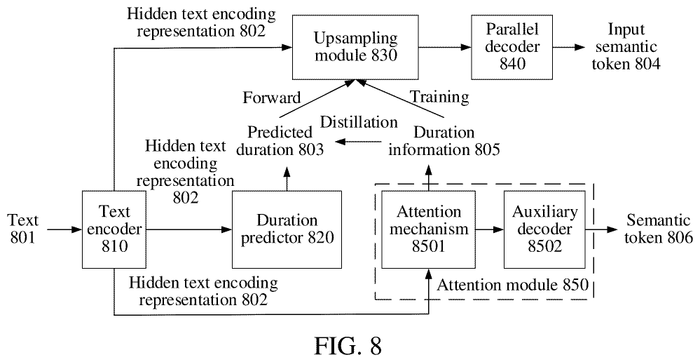

Refer to FIG. 8 which is a schematic diagram of a text-to-semantic token model according to an illustrative aspect as described herein.

After the foregoing semantic token extractor is trained, for any text-labeled audio (only this module is trained in a supervised manner in the technical solution as described herein), a semantic token may be extracted, to train a text-to-semantic token prediction module. As shown in FIG. 8, in comprehensive consideration of convenience of training and efficiency of reasoning, the text-to-semantic token model mainly includes a total of five parts, namely a text encoder 810, a duration predictor 820, an upsampling module 830, a parallel decoder 840, and an attention module 850.

The text encoder 810 is configured to encode an inputted text 801 to obtain a hidden text encoding representation 802. A text that needs to be synthesized (e.g., “I am Customer Service Amy, with Employee Number 1001. It's my pleasure to serve you.”) is preprocessed to obtain a regular text representation (e.g., pinyin), and the regular text representation is inputted into the text encoder 810. A specific structure of the text encoder 810 may be an RNN-based CBHG encoder (Tacotron) or a transformer block-based encoder (Fastspeech). The text encoder 810 abstracts the regular text representation layer into the hidden text encoding representation 802, for use by subsequent modules.

The duration predictor 820 inputs the hidden text encoding representation 802, and predicts a predicted duration 803 of pronunciation of each hidden text encoding representation 802. Since there is a length difference between the text that needs to be synthesized and a final acoustic feature (which may be understood as that a pronunciation duration of each word is different, and a quantity of acoustic feature frames corresponding thereto is different), the duration predictor 820 needs to predict a quantity of acoustic feature frames (or pronunciation duration) corresponding to each hidden text representation, to upsample the hidden text representation to a corresponding quantity of frames. A specific structure of the duration predictor 820 may be a pure CNN network or may be a CNN+RNN network.

The upsampling module 830 extends the hidden text encoding representation 802 to a corresponding quantity of frames according to the predicted duration 803 of the duration predictor 820 (if a predicted duration of a hidden text representation is 5, the hidden text representation is replicated 5 times).

For the parallel decoder 840, an input to the parallel decoder 840 is an upsampled hidden text representation, and an input semantic token 804 corresponding to a to-be-synthesized text is finally obtained by performing nonlinear transformation multiple times. The parallel decoder 840 may have a transformer structure or a pure CNN structure.

In this aspect as described herein, the same text 801 may be inputted into the trained semantic token extractor, to obtain a semantic token label corresponding to the text 801. A semantic token loss is determined based on the semantic token label and the input semantic token 804. The parallel decoder 840, the upsampling module 830, the duration predictor 820, and the text encoder 810 are trained based on the semantic token loss.

The attention module 850 includes two parts, namely an attention mechanism 8501 and an auxiliary decoder 8502. The attention mechanism 8501 may be various common attention mechanisms, for example, a location sensitive attention mechanism used in Tacotron or a Gaussian mixture model (GMM)-based attention mechanism, with a function of determining which hidden text representations are used for each decoding step. The auxiliary decoder 8502 may have a two-layer RNN structure. An alignment matrix between the hidden text encoding representation 802 and the acoustic feature is obtained by using the attention module 850 and is converted into duration information 805 (a quantity of acoustic feature frames) corresponding to each input text.

The attention module 850 is used only during the training, with a main function of acquiring the duration information 805 of the hidden text encoding representation 802. On the one hand, the acquired duration information 805 is taken as a label for training the duration predictor 820 (which is so-called distillation, i.e., a duration prediction capability learned by the attention module 850 is transferred to the duration predictor 820). On the other hand, the acquired duration information 805 is inputted into the upsampling module 830 to upsample the hidden text encoding representation 802. In a testing stage, the duration information 805 is directly predicted by using the duration predictor 820, and an output of the text encoder 810 is upsampled.

In this aspect as described herein, a duration prediction loss may be determined based on the predicted duration 803 and the duration information 805; and the duration predictor 820 and the text encoder 810 are trained based on the duration prediction loss.

In conclusion, as shown in FIG. 8, a training procedure of the text-to-semantic token prediction module is as follows:

After acquiring the text 801, the computer device outputs the hidden text encoding representation 802 corresponding to the text 801 by using the text encoder 810. The hidden text encoding representation 802 may be transmitted respectively to the duration predictor 820, the upsampling module 830, and the attention module 850, so that the attention mechanism 8501 in the attention module 850 determines an alignment matrix and an attention weight between the hidden text encoding representation 802 and the semantic token label based on the hidden text encoding representation 802 and the semantic token label corresponding to the text 801.

The attention module 850 further determines the duration information 805 corresponding to the hidden text encoding representation 802 based on the alignment matrix, and then the auxiliary decoder 8502 obtains a semantic token 806 based on the attention weight, the hidden text encoding representation 802, and the semantic token label.

The duration information 805 determined by the attention mechanism 8501 may be transmitted respectively to the duration predictor 820 and the upsampling module 830. The duration predictor 820 generates the predicted duration 803 based on the hidden text encoding representation 802. The upsampling module 830 performs upsampling processing on the hidden text encoding representation 802 based on the duration information 805, to obtain a hidden text extended representation. Further, the parallel decoder 840 decodes the hidden text extended representation, to obtain the input semantic token 804.

Finally, the computer device determines the duration prediction loss based on the duration information 805 and the predicted duration 803, and determines a semantic token prediction loss based on the semantic token label and the semantic token 806; and determines a second semantic token prediction loss based on the semantic token label and the input semantic token 804. Further, the text encoder 810, the duration predictor 820, the attention module 850, and the parallel decoder 840 are trained in an end-to-end manner based on the three losses, and the text-to-semantic token prediction module is constructed based on the text encoder 810, the duration predictor 820, and the parallel decoder 840 that are obtained by training.

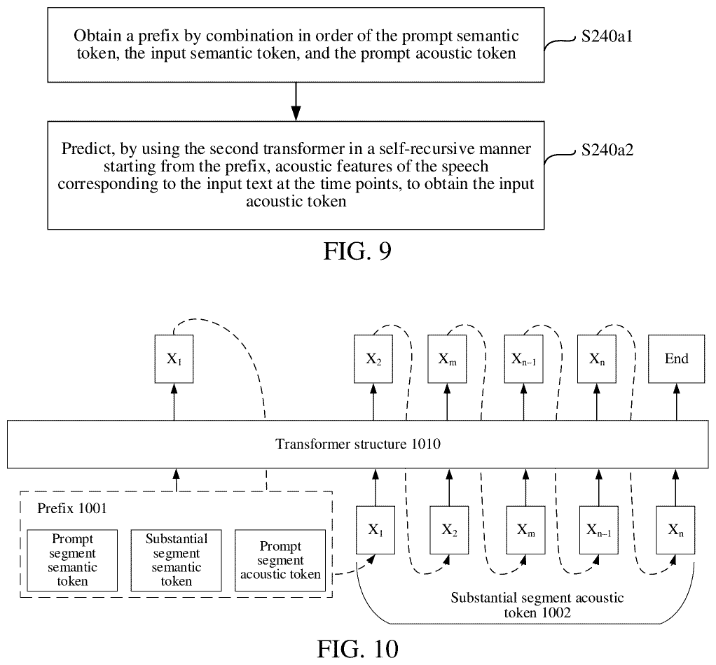

Based on the aspect shown in FIG. 3, FIG. 5, or FIG. 7, refer to FIG. 9 which is a flowchart of a speech synthesis method according to an illustrative aspect as described herein. As shown in FIG. 9, the semantic token-to-acoustic token model includes a second transformer, and operation 240a in the aspect shown in FIG. 3 may be implemented as operation 240a1 and operation 240a2.

Operation 240a1: Obtain a prefix by combination in order of the prompt semantic token, the input semantic token, and the prompt acoustic token.

In this aspect as described herein, the computer device may sequentially concatenate the prompt semantic token, the input semantic token, and the prompt acoustic token in order, to obtain the prefix. For example, a concatenation order may be randomly determined or may be preset.

Operation 240a2: Predict, by using the second transformer in a self-recursive manner starting from the prefix, acoustic features of the speech corresponding to the input text at the time points, to obtain the input acoustic token.

By using the second transformer, the acoustic features of the speech corresponding to the input text at the time points are predicted at the time points one by one in a self-recursive manner starting from the prefix, to obtain the input acoustic token.

In this aspect as described herein, the computer device processes the prefix by using the second transformer (the transformer network), predicts an acoustic token at the 1^{st} time point of the speech corresponding to the input text, concatenates the acoustic token at the 1^{st} time point to the prefix, inputs the acoustic token to the second transformer to obtain an acoustic token at the 2^{nd} time point of the speech corresponding to the input text, concatenates the acoustic token at the 2^{nd} time point to the acoustic token at the 1^{st} time point, which is re-inputted into the second transformer to obtain an acoustic token at the 3^{rd} time point of the speech corresponding to the input text, and so on, until acoustic features of the speech corresponding to the input text at all time points are predicted, to obtain the foregoing input acoustic token.

In some aspects, the second transformer is a neural network model configured to implement a conversion function, and the neural network model includes a plurality of neural network layers. In some aspects, the second transformer may be a transformer network. Certainly, the second transformer may alternatively be another neural network other than the transformer network, including, but not limited to, at least one of a bert network and a U-net network.

In this aspect as described herein, an implementable solution of predicting an input acoustic token by using a prompt semantic token, an input semantic token, and a prompt acoustic token is provided, to ensure implementability of conversion of a semantic token into an acoustic token.

In some aspects, orders of the prompt acoustic token and the input acoustic token are 2.

In this aspect as described herein, provided that the order of the acoustic token is 2, a requirement for accuracy of speech synthesis can be met. Compared with a related technology in which an acoustic token of about 8 orders is needed, the solution shown in this aspect as described herein can greatly reduce model complexity and improve model processing efficiency.

In some aspects, the above method further includes:
acquiring a third audio sample and a fourth audio sample when training of the semantic token extractor and the acoustic token extractor is completed; the third audio sample and the fourth audio sample being two non-overlapping audio segments in a same audio;
separately extracting a semantic token label of the third audio sample and a semantic token label of the fourth audio sample by using the semantic token extractor;
separately extracting an acoustic token label of the third audio sample and an acoustic token label of the fourth audio sample by using the acoustic token extractor;
obtaining a prefix sample by combination in order of the semantic token label of the third audio sample, the semantic token label of the fourth audio sample, and the acoustic token label of the third audio sample;
predicting, by using the second transformer, an acoustic token sample of the fourth audio sample in a self-recursive manner starting from the prefix sample; and
updating a parameter of the semantic token-to-acoustic token model based on the acoustic token sample of the fourth audio sample and the acoustic token label of the fourth audio sample.

In some aspects, a loss function value of the semantic token-to-acoustic token model is acquired based on the acoustic token sample of the fourth audio sample and the acoustic token label of the fourth audio sample; and
the parameter of the semantic token-to-acoustic token model is updated based on the loss function value of the semantic token-to-acoustic token model.

For example, the parameter of the semantic token-to-acoustic token model is updated with a goal of minimizing the loss function value. A specific type of the loss function is not limited as described herein. For example, the loss function is a cross-entropy loss, a 0-1 loss function, an absolute-value loss function, a logarithmic loss function, an exponential loss function, a perceptual loss function, or the like. For example, parameters of the modules in the semantic token-to-acoustic token model are updated with a goal of minimizing the loss function value. For example, a parameter of a target module in the modules in the semantic token-to-acoustic token model is updated with a goal of minimizing the loss function value. In this manner, training costs can be reduced, and training efficiency can be improved.

In the solution shown in this aspect as described herein, by using the semantic token extractor and the acoustic token extractor, non-overlapping segments in a same audio may be respectively taken as a sample of a prompt audio and a sample of a text, to calculate a loss in a process of predicting an acoustic token by using the semantic token-to-acoustic token model, thereby implementing unsupervised training on the semantic token-to-acoustic token model without relying on labeled data, reducing a requirement for training data and ensuring model accuracy.

Refer to FIG. 10 which is a schematic diagram of a semantic token-to-acoustic token model according to an illustrative aspect as described herein. As shown in FIG. 10, after training of the semantic token and acoustic token extractors is completed, a semantic token and an acoustic token may be simultaneously extracted for an audio, to train a semantic token-to-acoustic token prediction module. The process is also unsupervised training and only requires a large amount of unlabeled audio data.

The semantic token-to-acoustic token model is a transformer structure 1010 with 12 layers, 12 heads, and a dimensionality of 768. A t^{th} token is predicted by using a language model training manner, that is, by inputting 1 to t-1 tokens. A cross-entropy loss is taken as the loss function.

During training, two non-overlapping segments (one segment is used as a prompt segment, and the other segment is used as a substantial segment) of a same audio are taken, semantic tokens and acoustic tokens are respectively extracted, a prompt segment semantic token, a substantial segment semantic token, and a prompt segment acoustic token are taken as a prefix 1001, to predict a substantial segment acoustic token 1002 in a self-recursive manner.

Specifically, for example, when the prefix 1001 and a first substantial segment acoustic token X₁ are known, a second substantial segment acoustic token X₂ is predicted; when the prefix 1001, the first substantial segment acoustic token X₁, and the second substantial segment acoustic token X₂ are known, a third substantial segment acoustic token X₃ is predicted; and so on.

During reasoning, a semantic token and an acoustic token are extracted for an output audio segment, a semantic token corresponding to a to-be-synthesized text forms a prefix in a same order, and a to-be-synthesized acoustic token is predicted in a self-recursive manner. Since a target segment does not appear in a training set, this belongs to zero-shot synthesis.

In addition, the foregoing acoustic token extractor is a convolution-based encoder-decoder structure. The encoder includes a one-dimensional convolution layer with C channels and a kernel size of 7, four convolution blocks, two LSTM layers, and a one-dimensional convolution layer with D channels and a kernel size of 7. Each convolution block includes two convolution layers with a kernel size of 3 and one convolution layer with a step of S. Steps of the four convolution blocks are set to (2, 4, 5, 8) respectively. After processing by the convolution layer with the step of S, the length is changed to 1/S of the original, and a quantity of channels is doubled. After processing by the encoder, the length is downsampled by a factor of 320. That is, a one-second 24-kHz audio (24000 sampling points) is inputted, and the encoder outputs corresponding 75 frames of hidden-layer representations with a dimensionality of D. The decoder is a mirror structure of the encoder, and only the convolution layer with the step of S in the convolution block is replaced with a deconvolution layer, so as to implement a corresponding upsampling factor. That is, quantized 75 frames of hidden-layer representations with a dimensionality of D are upsampled back to 24000 sampling points.

A residual vector quantizer (RVQ) is connected to the encoder and the decoder, which quantizes an output of the encoder and then inputs the quantized output into the decoder. A quantization process mainly involves mapping a hidden-layer representation outputted by the encoder to an object that is in a codebook and has a minimum distance therewith. The RVQ employs a plurality of codebooks to perform quantization multiple times in a cyclic manner, with a previous residual quantized each time.

In the technical solution of this aspect as described herein, 8 codebooks each with a size of K and a dimensionality of D are employed. A residual operation is performed on a result obtained from the first quantization and an original hidden-layer representation, and serves as an input to the second quantization. A residual operation is performed on a result obtained from the second quantization and the input to the second quantization, and serves as an input to the third quantization. The rest may be deduced by analogy eight times. Outputs from all quantization operations are summed to form a final quantized hidden-layer representation which is inputted into the decoder. During training, a large quantity of unlabeled audios are used for training, and a reconstruction error between an input audio and an output audio is taken as a loss function. During reasoning, the acoustic token is extracted only by using the encoder and the RVQ. For a one-second 24-khz audio, the encoder outputs 75 frames of hidden-layer representations with a dimensionality of D. Only the first two quantization operations are performed, and quantized indices are taken as acoustic token values. For example, if a first-frame hidden-layer representation has a minimum distance to a third vector in a first codebook, 3 is recorded. After a residual between the first-frame hidden-layer representation and the third vector in the first codebook is calculated, if a distance to a seventh vector in a second codebook is shortest, 7 is recorded. Therefore, the acoustic token corresponding to the first-frame hidden-layer representation is denoted as (3, 7). In conclusion, the one-second 24-khz audio is converted into 2×75 acoustic tokens.

After training of the foregoing acoustic token extractor is completed, a corresponding acoustic token may be extracted for any audio, and the sound decoder is trained in an unsupervised manner, to implement quick conversion from the acoustic token to the audio.

The foregoing sound decoder is an acoustic token-based parallel vocoder. A structure of the acoustic token-based parallel vocoder is similar to that of a generative adversarial network (GAN)-based high-speed neural vocoder (HiFiGAN), and a difference is that an acoustic token is inputted instead of a Mel acoustic feature. Embedding needs to be first performed on acoustic tokens of different orders (which are 2-order in this technical solution) respectively, resulting in a matrix of a quantity of frames×2 orders×Ed as an input to the generator. The remaining structure is consistent with that of the HiFiGAN.

The generator mainly includes two blocks. One is an upsampling structure, specifically including a one-dimensional transposed convolution (the technical solution as described herein requires upsampling the acoustic token by a factor of 320). The other is a multi-receptive field fusion (MRF) module, mainly responsible for optimizing sampling points obtained by upsampling and specifically including a residual network.

There are two discriminators, which are respectively a multi-scale discriminator and a multi-period discriminator and respectively identify a speech from two different perspectives:

The multi-scale discriminator continuously averagely pools a speech sequence, sequentially halves a length of the speech sequence, then applies several layers of convolution to different scales of the speech, and finally flattens the speech sequence as an output of the multi-scale discriminator.

The multi-period discriminator folds a one-dimensional audio sequence into a two-dimensional plane by using different sequence lengths, and applies two-dimensional convolution to the two-dimensional plane.

In a speech synthesis technology, a text is converted into corresponding audio content by using a rule or a model algorithm. A conventional speech synthesis technology is mainly based on a concatenation method or a statistical parametric method. As deep learning continues to make breakthroughs in the field of speech recognition, some cutting-edge Internet companies at home and abroad have begun to introduce deep learning into the field of speech synthesis and have made great progress.

Specifically, for example, in a related technology, an audio codec is trained in an unsupervised manner by using massive audio data, and an intermediate quantized value of the codec is used as an acoustic token. Then, the acoustic token is extracted from text-labeled audio data, and a text-to-acoustic token module is trained. In actual use, an acoustic token is predicted from a text, and then the acoustic token is inputted into a decoding part of the audio codec, to generate a final audio. As described above, the following problems need to be resolved in the related technical solutions:

Firstly, the acoustic token is directly predicted from the text, resulting in an excessively large span. Therefore, a large amount of labeled data is required for training.

Secondly, the acoustic token is converted into an audio by using the decoding part of the audio codec, and there is a need to predict a higher-order acoustic token from the text (for example, eight-order residual vector quantization) to obtain better synthesis quality. Therefore, the text-to-acoustic token module is relatively complex and requires two prediction stages, including an autoregressive stage and a non-autoregressive stage, which makes overall computational efficiency low.

For the foregoing problem, in the technical solution as described herein, a semantic token is introduced as transition, so that a one-to-many problem faced when an acoustic token is directly predicted from a text can be alleviated, and dependency on labeled data can be reduced.

In addition, a parallel vocoder based on a two-order acoustic token is further introduced to the technical solution as described herein. On the one hand, the order of the acoustic token that needs to be predicted can be reduced, so that the semantic token-to-acoustic token model needs only one autoregressive stage. On the other hand, the parallel vocoder can significantly reduce a time required for conversion from an acoustic token to an audio.

Based on the foregoing aspect as described herein, a semi-supervised speech synthesis system may be constructed. The system includes five parts, namely a text-to-semantic token model, a semantic token extractor, an acoustic token extractor, a semantic token-to-acoustic token model, and an acoustic token vocoder. Except for the text-to-semantic token model that requires a small amount of text-labeled audio data for training, the remaining four parts only need massive unlabeled audio for training.

In the foregoing semi-supervised speech synthesis system, an emotion massive unlabeled audio data, and a semantic token extractor and an acoustic token extractor that are obtained by unsupervised training are effectively utilized to mine information such as semantics, a timbre, a rhythm, and an emotion in the audio data, so that zero-shot speech synthesis may be implemented by using a target prompt segment. In addition, predicting a semantic token from a text can alleviate a one-to-many problem faced when an acoustic feature is directly predicted from the text, thereby greatly reducing labeled data required for training. Finally, quick conversion from an acoustic token to an audio is implemented by using the acoustic token-based parallel vocoder. The innovative semi-supervised speech synthesis system, on the one hand, makes full use of easily available unlabeled audio data, greatly reducing dependence on labeled audio data. On the other hand, on the premise of considering operation efficiency, a capability of controlling generated content by using prompt words similar to that of a large language model is implemented. The speech synthesis system may alternatively control a synthesized audio by using the target prompt segment, to implement zero-shot synthesis.

Specifically, for example, the system is controlled, by using a prompt segment including a target timbre (for example, a cartoon character A) and a target emotion (happy), to synthesize a corresponding audio (the timbre of the happy cartoon character A has never appeared in the training set, and therefore, it is zero-shot synthesis).

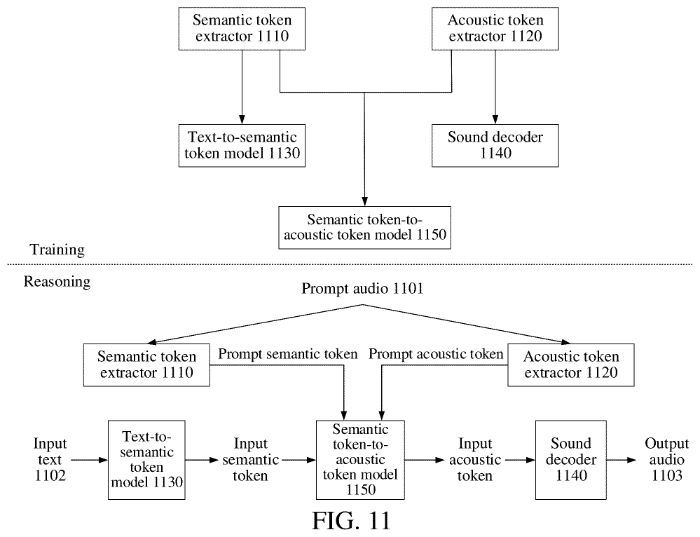

Refer to FIG. 11 which is an illustrative training and reasoning flowchart of a speech synthesis system according to this application.

As shown in FIG. 11, an illustrative semi-supervised training procedure of the speech synthesis system as referred to as described herein is as follows:
Operation A1: Perform unsupervised training on a semantic token extractor 1110 by using massive unlabeled audio data.
Operation A2: Perform unsupervised training on an acoustic token extractor 1120 by using the massive unlabeled audio data.
Operation A3: Based on the semantic token extractor 1110 trained in operation A1, perform supervised training on a text-to-semantic token model 1130 by using a small amount of text-labeled audio data.
Operation A4: Based on the acoustic token extractor 1120 trained in operation A2, perform unsupervised training on a sound decoder 1140 by using the massive unlabeled audio data.
Operation A5: Based on the semantic token extractor 1110 trained in operation A1 and the acoustic token extractor 1120 trained in operation A2, perform unsupervised training on a semantic token-to-acoustic token model 1150 by using the massive unlabeled audio data.

As shown in FIG. 11, an illustrative reasoning procedure of the speech synthesis system as referred to as described herein is as follows:
Operation B1: After a prompt audio 1101 is inputted into the semantic token extractor 1110 and the semantic token extractor 1110 performs reasoning on the prompt audio 1101, a prompt semantic token corresponding to the prompt audio 1101 may be obtained.
Operation B2: After the prompt audio 1101 is inputted into the acoustic token extractor 1120 and the acoustic token extractor 1120 performs reasoning on the prompt audio 1101, a prompt acoustic token corresponding to the prompt audio 1101 may be obtained.
Operation B3: After an input text 1102 is inputted into the text-to-semantic token model 1130 and the text-to-semantic token model 1130 performs reasoning on the input text 1102, an input semantic token corresponding to the input text 1102 may be obtained.
Operation B4: After the prompt semantic token obtained in operation B1, the prompt acoustic token obtained in operation B2, and the input semantic token obtained in operation B3 are inputted into the semantic token-to-acoustic token model 1150 and the semantic token-to-acoustic token model 1150 performs reasoning, an input acoustic token corresponding to the input text 1102 may be obtained.
Operation B5: After the input acoustic token obtained in operation B4 is inputted into the sound decoder 1140 and the sound decoder 1140 performs reasoning on the input acoustic token, an output audio 1103 corresponding to the input text 1102 may be obtained.

This application has a wide range of application scenarios, and a speech synthesis system trained in a semi-supervised manner may be placed on a cloud service, serving as a basic technology to empower a user using the cloud service.

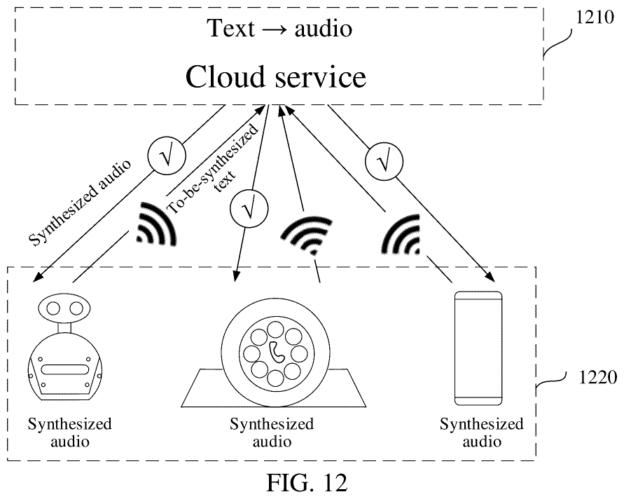

Refer to FIG. 12 which is a schematic diagram of an illustrative application scenario of a speech synthesis system according to this application. As shown in FIG. 12, the speech synthesis system is deployed to a cloud service, to provide a controllable speech synthesis service for a customer.

A specific invoking process is as follows:
1. The customer uploads a to-be-synthesized text and a prompt audio by using a device 1210 accessing the cloud service.
2. A server end 1220 transmits a corresponding synthesized audio to the device 1210 in a form of streaming or full-sentence return after performing rapid synthesis based on the speech synthesis system.

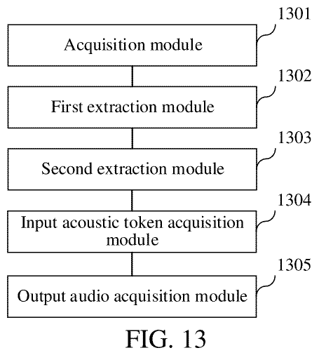

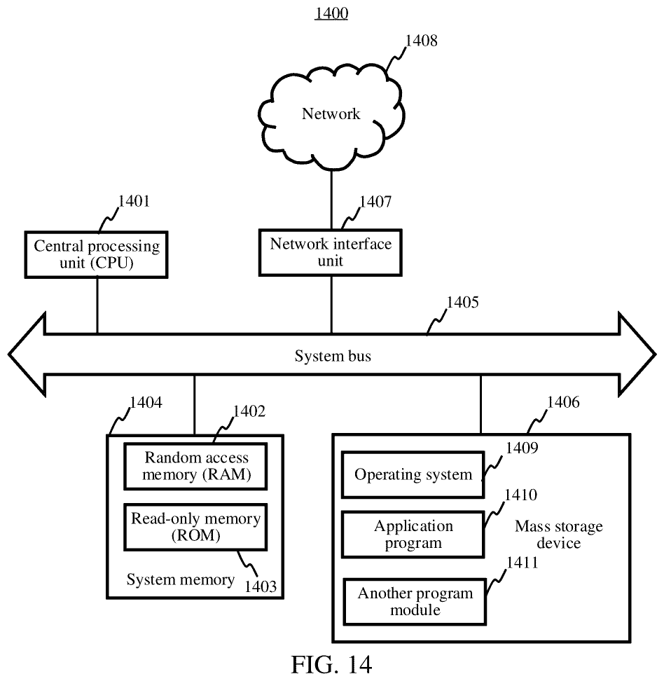

FIG. 13 is a block diagram of a speech synthesis apparatus according to an illustrative aspect as described herein. The apparatus may be configured to perform all or some operations in the method shown in FIG. 2, FIG. 3, or FIG. 4 that are performed by the computer device. As shown in FIG. 13, the apparatus includes:
an acquisition module 1301, configured to acquire an input text and a prompt audio;
a first extraction module 1302, configured to perform feature extraction on the prompt audio to obtain a prompt semantic token and a prompt acoustic token, the prompt semantic token being configured for indicating semantic features of the prompt audio at respective time points, and the prompt acoustic token being configured for indicating acoustic features of the prompt audio at the time points;
a second extraction module 1303, configured to perform feature extraction on the input text to obtain an input semantic token, the input semantic token being configured for indicating semantic features of a speech corresponding to the input text at the time points;
an input acoustic token acquisition module 1304, configured to acquire an input acoustic token based on the prompt semantic token, the prompt acoustic token, and the input semantic token; the input acoustic token being configured for indicating acoustic features of the speech corresponding to the input text at the time points; and
an output audio acquisition module 1305, configured to acquire an output audio of the input text based on the input acoustic token.

In some aspects, the first extraction module 1302 is configured to input the prompt audio into a semantic token extractor to obtain the prompt semantic token obtained by the semantic token extractor by processing the prompt audio, the semantic token extractor being a machine learning model configured to extract a semantic feature from an audio; and
input the prompt audio into an acoustic token extractor to obtain the prompt acoustic token obtained by the acoustic token extractor by processing the prompt audio, the acoustic token extractor being a machine learning model configured to extract an acoustic feature from the audio;
the second extraction module 1303 is configured to input the input text into a text-to-semantic token model to obtain the input semantic token obtained by the text-to-semantic token model by processing the input text, the text-to-semantic token model being a machine learning model configured to extract a semantic feature from a text;
the input acoustic token acquisition module 1304 is configured to input the prompt semantic token, the prompt acoustic token, and the input semantic token into a semantic token-to-acoustic token model, to obtain the input acoustic token outputted by the semantic token-to-acoustic token model, the semantic token-to-acoustic token model being a machine learning model configured to convert a semantic feature into an acoustic feature; and
the output audio acquisition module 1305 is configured to input the input acoustic token into a sound decoder to obtain the output audio outputted by the sound decoder.

In some aspects, the semantic token extractor includes a convolution branch and a first transformer; and the first extraction module 1302 is configured to
input the prompt audio into the convolution branch to obtain hidden-layer features, which are outputted by the convolution branch, of the prompt audio at the time points;
process the hidden-layer features of the prompt audio at the time points by using the first transformer, to obtain intermediate-layer features, which are outputted by an intermediate layer of the first transformer, of the prompt audio at the time points; and
cluster the intermediate-layer features of the prompt audio at the time points to obtain the prompt semantic token.

In some aspects, the apparatus further includes: a semantic token extractor training module, configured to
input a first audio sample into the convolution branch to obtain hidden-layer feature samples, which are outputted by the convolution branch, of the first audio sample at the time points;
partially mask the hidden-layer feature samples of the first audio sample at the time points to obtain partially masked hidden-layer feature samples;
process the partially masked hidden-layer feature samples by using the first transformer, to obtain intermediate-layer features, which are outputted by the intermediate layer of the first transformer, of the first audio sample at the time points;
cluster the intermediate-layer features of the first audio sample at the time points to obtain a semantic token sample of the first audio sample; and
update a parameter of the semantic token extractor based on the semantic token sample of the first audio sample and the semantic token label of the first audio sample.

In some aspects, the text-to-semantic token model includes a text encoder, a duration predictor, an upsampling branch, and a decoder; and
the second extraction module 1303 is configured to
input the input text into the text encoder to obtain a hidden text encoding representation of the input text;
input the hidden text encoding representation into the duration predictor to obtain a playback duration, which is predicted by the duration predictor, of the speech corresponding to the input text;
upsample, by using the upsampling branch, the hidden text encoding representation to a quantity of frames corresponding to the playback duration, to obtain an upsampled hidden text encoding representation; and
decode the upsampled hidden text encoding representation by using the decoder, to obtain the input semantic token.

In some aspects, the apparatus further includes: a text-to-semantic token model training module, configured to
acquire a second audio sample and a speech text of the second audio sample when training of the semantic token extractor is completed;
input the second audio sample into the semantic token extractor to obtain a semantic token label, which is outputted by the semantic token extractor, of the second audio sample;
input the speech text of the second audio sample into the text-to-semantic token model to obtain a semantic token sample, which is outputted by the text-to-semantic token model, of the second audio sample; and
update a parameter of the text-to-semantic token model based on the semantic token sample of the second audio sample and the semantic token label of the second audio sample.

In some aspects, the text-to-semantic token model training module is further configured to
input the speech text of the second audio sample into the text encoder to obtain a hidden text encoding representation sample of the speech text of the second audio sample;
input the hidden text encoding representation sample into the duration predictor to obtain a first playback duration sample, which is predicted by the duration predictor, of a speech corresponding to the speech text of the second audio sample;
input the hidden text encoding representation sample into an attention branch to obtain a second playback duration sample, which is outputted by the attention branch, of the speech corresponding to the speech text of the second audio sample;
upsample, by using the upsampling branch, the hidden text encoding representation sample to a quantity of frames corresponding to the second playback duration sample, to obtain an upsampled hidden text encoding representation sample;
decode the upsampled hidden text encoding representation sample by using the decoder, to obtain the semantic token sample of the second audio sample;
acquire a loss function value of the text-to-semantic token model based on the first playback duration sample, the second playback duration sample, the semantic token sample of the second audio sample, and the semantic token label of the second audio sample; and
update the parameter of the text-to-semantic token model based on the loss function value of the text-to-semantic token model.

In some aspects, the text-to-semantic token model training module is configured to
acquire a first loss function value of the text-to-semantic token model based on a difference between the first playback duration sample and the second playback duration sample;
acquire a second loss function value of the text-to-semantic token model based on a difference between the semantic token sample of the second audio sample and the semantic token label of the second audio sample; and
determine the loss function value of the text-to-semantic token model based on the first loss function value of the text-to-semantic token model and the second loss function value of the text-to-semantic token model.

In some aspects, the semantic token-to-acoustic token model includes a second transformer; and the input acoustic token acquisition module 1304 is configured to
obtain a prefix by combination in order of the prompt semantic token, the input semantic token, and the prompt acoustic token; and
predict, by using the second transformer in a self-recursive manner starting from the prefix, acoustic features of the speech corresponding to the input text at the time points, to obtain the input acoustic token.

In some aspects, orders of the prompt acoustic token and the input acoustic token are 2.

In some aspects, the apparatus further includes: a semantic token-to-acoustic token model training module, configured to
acquire a third audio sample and a fourth audio sample when training of the semantic token extractor and the acoustic token extractor is completed; the third audio sample and the fourth audio sample being two non-overlapping audio segments in a same audio;
separately extract a semantic token label of the third audio sample and a semantic token label of the fourth audio sample by using the semantic token extractor;
separately extract an acoustic token label of the third audio sample and an acoustic token label of the fourth audio sample by using the acoustic token extractor;
obtain a prefix sample by combination in order of the semantic token label of the third audio sample, the semantic token label of the fourth audio sample, and the acoustic token label of the third audio sample;
predict, by using the second transformer, an acoustic token sample of the fourth audio sample in a self-recursive manner starting from the prefix sample; and
update a parameter of the semantic token-to-acoustic token model based on the acoustic token sample of the fourth audio sample and the acoustic token label of the fourth audio sample.

FIG. 14 is a structural block diagram of a computer device 1400 according to an illustrative aspect as described herein. The computer device may be implemented as the server in the foregoing solution as described herein. The computer device 1400 includes a central processing unit (CPU) 1401, a system memory 1404 including a random access memory (RAM) 1402 and a read-only memory (ROM) 1403, and a system bus 1405 connecting the system memory 1404 and the CPU 1401. The computer device 1400 further includes a mass storage device 1406 configured to store an operating system 1409, an application program 1410, and another program module 1411.

The mass storage device 1406 is connected to the CPU 1401 by using a mass storage controller (not shown) connected to the system bus 1405. The mass storage device 1406 and a computer-readable medium associated therewith provide non-volatile storage for the computer device 1400. That is, the mass storage device 1406 may include a computer-readable medium (not shown) such as a hard disk or a compact disc read-only memory (CD-ROM) drive.

Generally, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes a RAM, a ROM, an erasable programmable read only memory (EPROM), an electrically-erasable programmable read-only memory (EEPROM), a flash memory or another solid-state storage technology, a CD-ROM, a digital versatile disc (DVD) or another optical storage, a cassette, a magnetic tape, a disk storage, or another magnetic storage device. Certainly, a person skilled in art can know that the computer storage medium is not limited to the foregoing several types. The system memory 1404 and the mass storage device 1406 may be collectively referred to as a memory.

According to the aspects of the present disclosure, the computer device 1400 may be further connected, by using a network such as the Internet, to a remote computer on the network and run. That is, the computer device 1400 may be connected to a network 1408 by using a network interface unit 1407 connected to the system bus 1405, or may be connected to another type of network or a remote computer system (not shown) by using the network interface unit 1407.

The memory further includes at least one computer program. The at least one computer program is stored in a memory. The CPU 1401 executes the at least one computer program to implement all or some of the operations in the method shown in various aspects described above.

In an illustrative aspect, a chip is further provided. The chip includes a programmable logic circuit and/or program instructions. When running on a computer device, the chip is configured to implement the speech synthesis method according to the foregoing aspect.

In an illustrative aspect, a computer program product is further provided. The computer program product includes computer instructions. The computer instructions are stored in a computer-readable storage medium. A processor of a computer device reads the computer instructions from the computer-readable storage medium, and the processor reads, from the computer-readable storage medium, and executes the computer instructions to implement the speech synthesis method provided in the foregoing method aspects.

In an illustrative aspect, a computer-readable storage medium is further provided. The computer-readable storage medium has a computer program stored therein. The computer program is loaded and executed by a processor to implement the speech synthesis method provided in the foregoing method aspects.

A person of ordinary skill in the art may understand that all or some of the steps of the foregoing aspects may be implemented by hardware, or may be implemented by a program instructing relevant hardware. The program may be stored in a computer-readable storage medium. The storage medium may be a ROM, a magnetic disk, an optical disc, or the like.

A person skilled in the art may be aware that in the foregoing one or more examples, functions described in the aspects as described herein may be implemented by using hardware, software, firmware, or any combination thereof. When implemented by using software, the functions may be stored in a computer-readable medium or may be used as one or more instructions or code in a computer-readable medium for transmission. The computer-readable medium includes a computer storage medium and a communication medium. The communication medium includes any medium that enables a computer program to be transmitted from one place to another. The storage medium may be any available medium accessible to a general-purpose or special-purpose computer.

The foregoing description is illustrative of aspects as described herein, and is not intended to limit this application. Any modification, equivalent replacement, and improvement made within the spirit and principle as described herein falls is limited only by the claims.

What is claimed is:

1. A computer-implemented speech synthesis method comprising:
performing feature extraction on a prompt audio to obtain a prompt semantic token and a prompt acoustic token, the prompt semantic token being configured for indicating semantic features of the prompt audio at respective time points, and the prompt acoustic token being configured for indicating acoustic features of the prompt audio at the time points;
performing feature extraction on an input text to obtain an input semantic token, the input semantic token being configured for indicating semantic features of a speech corresponding to the input text at the time points;
generating an input acoustic token based on the prompt semantic token, the prompt acoustic token, and the input semantic token; the input acoustic token being configured for indicating acoustic features of the speech corresponding to the input text at the time points; and
generating an output audio of the input text based on the input acoustic token.

2. The method according to claim 1, wherein the performing feature extraction on the prompt audio comprises:
inputting the prompt audio into a semantic token extractor to generate the prompt semantic token, wherein the semantic token extractor generates the prompt semantic token based on the prompt audio, the semantic token extractor being a machine learning model configured to extract a semantic feature from an audio; and
inputting the prompt audio into an acoustic token extractor to generate the prompt acoustic token, wherein the acoustic token extractor generates the prompt acoustic token based on the prompt audio, the acoustic token extractor being a machine learning model configured to extract an acoustic feature from the audio;
wherein the performing feature extraction on the input text comprises:
inputting the input text into a text-to-semantic token model to generate the input semantic token, wherein the text-to-semantic token model generates the input semantic token based on the input text, the text-to-semantic token model being a machine learning model configured to extract a semantic feature from a text;
wherein the generating the input acoustic token comprises:
inputting the prompt semantic token, the prompt acoustic token, and the input semantic token into a semantic token-to-acoustic token model, to generate the input acoustic token, the semantic token-to-acoustic token model being a machine learning model configured to convert a semantic feature into an acoustic feature; and
wherein generating the output audio comprises:
inputting the input acoustic token into a sound decoder to generate the output audio.

3. The method according to claim 2, wherein the semantic token extractor comprises a convolution branch and a first transformer; and
the inputting the prompt audio into the semantic token extractor comprises:
inputting the prompt audio into the convolution branch to obtain hidden-layer features, which are outputted by the convolution branch, of the prompt audio at the time points;
processing the hidden-layer features of the prompt audio at the time points by using the first transformer, to obtain intermediate-layer features, which are outputted by an intermediate layer of the first transformer, of the prompt audio at the time points; and
clustering the intermediate-layer features of the prompt audio at the time points to obtain the prompt semantic token.

4. The method according to claim 3, wherein the method further comprises:
acquiring a first audio sample and a semantic token label of the first audio sample;
inputting the first audio sample into the convolution branch to obtain hidden-layer feature samples, which are outputted by the convolution branch, of the first audio sample at the time points;
partially masking the hidden-layer feature samples of the first audio sample at the time points to obtain partially masked hidden-layer feature samples;
processing the partially masked hidden-layer feature samples by using the first transformer, to obtain intermediate-layer features, which are outputted by the intermediate layer of the first transformer, of the first audio sample at the time points;
clustering the intermediate-layer features of the first audio sample at the time points to obtain a semantic token sample of the first audio sample; and
updating a parameter of the semantic token extractor based on the semantic token sample of the first audio sample and the semantic token label of the first audio sample.

5. The method of claim 2, wherein the text-to-semantic token model comprises a text encoder, a duration predictor, an upsampling branch, and a decoder; and
the inputting the input text into the text-to-semantic token model comprises:
inputting the input text into the text encoder to obtain a hidden text encoding representation of the input text;
inputting the hidden text encoding representation into the duration predictor to obtain a playback duration, which is predicted by the duration predictor, of the speech corresponding to the input text;
upsampling, by using the upsampling branch, the hidden text encoding representation to a quantity of frames corresponding to the playback duration, to obtain an upsampled hidden text encoding representation; and
decoding the upsampled hidden text encoding representation by using the decoder, to obtain the input semantic token.

6. The method according to claim 5, wherein the method further comprises:
acquiring a second audio sample and a speech text of the second audio sample when training of the semantic token extractor is completed;
inputting the second audio sample into the semantic token extractor to generate a semantic token label of the second audio sample;
inputting the speech text of the second audio sample into the text-to-semantic token model to generate a semantic token sample of the second audio sample; and
updating a parameter of the text-to-semantic token model based on the semantic token sample of the second audio sample and the semantic token label of the second audio sample.

7. The method according to claim 6, wherein the inputting the speech text of the second audio sample into the text-to-semantic token model comprises:
inputting the speech text of the second audio sample into the text encoder to generate a hidden text encoding representation sample of the speech text of the second audio sample;
inputting the hidden text encoding representation sample into the duration predictor to generate a first playback duration sample predicted by the duration predictor, of a speech corresponding to the speech text of the second audio sample;
inputting the hidden text encoding representation sample into an attention branch to generate a second playback duration sample of the speech corresponding to the speech text of the second audio sample;
upsampling, using the upsampling branch, the hidden text encoding representation sample to a quantity of frames corresponding to the second playback duration sample, to generate an upsampled hidden text encoding representation sample; and
decoding the upsampled hidden text encoding representation sample using the decoder, to obtain the semantic token sample of the second audio sample; and
the updating the parameter of the text-to-semantic token model comprises:
acquiring a loss function value of the text-to-semantic token model based on the first playback duration sample, the second playback duration sample, the semantic token sample of the second audio sample, and the semantic token label of the second audio sample; and
updating the parameter of the text-to-semantic token model based on the loss function value of the text-to-semantic token model.

8. The method according to claim 7, wherein the acquiring the loss function value comprises:
acquiring a first loss function value of the text-to-semantic token model based on a difference between the first playback duration sample and the second playback duration sample;
acquiring a second loss function value of the text-to-semantic token model based on a difference between the semantic token sample of the second audio sample and the semantic token label of the second audio sample; and
determining the loss function value of the text-to-semantic token model based on the first loss function value of the text-to-semantic token model and the second loss function value of the text-to-semantic token model.

9. The method of claim 2, wherein the semantic token-to-acoustic token model comprises a transformer; and
the inputting the prompt semantic token, the prompt acoustic token, and the input semantic token into the semantic token-to-acoustic token model comprises:
obtaining a prefix by combination in order of the prompt semantic token, the input semantic token, and the prompt acoustic token; and
predicting, using the transformer in a self-recursive manner starting from the prefix, acoustic features of the speech corresponding to the input text at the time points, to obtain the input acoustic token.

10. The method according to claim 9, wherein orders of the prompt acoustic token and the input acoustic token are 2.

11. The method according to claim 9, wherein the method further comprises:
acquiring a third audio sample and a fourth audio sample when training of the semantic token extractor and the acoustic token extractor is completed; the third audio sample and the fourth audio sample being two non-overlapping audio segments in a same audio;
separately extracting a semantic token label of the third audio sample and a semantic token label of the fourth audio sample using the semantic token extractor;
separately extracting an acoustic token label of the third audio sample and an acoustic token label of the fourth audio sample by using the acoustic token extractor;
obtaining a prefix sample by combination in order of the semantic token label of the third audio sample, the semantic token label of the fourth audio sample, and the acoustic token label of the third audio sample;
predicting, using the transformer, an acoustic token sample of the fourth audio sample in a self-recursive manner starting from the prefix sample; and
updating a parameter of the semantic token-to-acoustic token model based on the acoustic token sample of the fourth audio sample and the acoustic token label of the fourth audio sample.

12. One or more non-transitory computer readable media comprising computer readable instructions that, when executed by a processor, configure a data processing system to perform:
performing feature extraction on a prompt audio to obtain a prompt semantic token and a prompt acoustic token, the prompt semantic token being configured for indicating semantic features of the prompt audio at respective time points, and the prompt acoustic token being configured for indicating acoustic features of the prompt audio at the time points;
performing feature extraction on an input text to obtain an input semantic token, the input semantic token being configured for indicating semantic features of a speech corresponding to the input text at the time points;
generating an input acoustic token based on the prompt semantic token, the prompt acoustic token, and the input semantic token; the input acoustic token being configured for indicating acoustic features of the speech corresponding to the input text at the time points; and
generating an output audio of the input text based on the input acoustic token.

13. The computer readable media according to claim 12, wherein the performing feature extraction on the prompt audio comprises:
inputting the prompt audio into a semantic token extractor to generate the prompt semantic token, wherein the semantic token extractor generates the prompt semantic token based on the prompt audio, the semantic token extractor being a machine learning model configured to extract a semantic feature from an audio; and
inputting the prompt audio into an acoustic token extractor to generate the prompt acoustic token, wherein the acoustic token extractor generates the prompt acoustic token based on the prompt audio, the acoustic token extractor being a machine learning model configured to extract an acoustic feature from the audio;
wherein the performing feature extraction on the input text comprises:
inputting the input text into a text-to-semantic token model to generate the input semantic token, wherein the text-to-semantic token model generates the input semantic token based on the input text, the text-to-semantic token model being a machine learning model configured to extract a semantic feature from a text;
wherein the generating the input acoustic token comprises:
inputting the prompt semantic token, the prompt acoustic token, and the input semantic token into a semantic token-to-acoustic token model, to generate the input acoustic token, the semantic token-to-acoustic token model being a machine learning model configured to convert a semantic feature into an acoustic feature; and
wherein generating the output audio comprises:
inputting the input acoustic token into a sound decoder to generate the output audio.

14. The computer readable media according to claim 13, wherein the semantic token extractor comprises a convolution branch and a first transformer; and
the inputting the prompt audio into the semantic token extractor comprises:
inputting the prompt audio into the convolution branch to obtain hidden-layer features, which are outputted by the convolution branch, of the prompt audio at the time points;
processing the hidden-layer features of the prompt audio at the time points by using the first transformer, to obtain intermediate-layer features, which are outputted by an intermediate layer of the first transformer, of the prompt audio at the time points; and
clustering the intermediate-layer features of the prompt audio at the time points to obtain the prompt semantic token.

15. The computer readable media of claim 13, wherein the text-to-semantic token model comprises a text encoder, a duration predictor, an upsampling branch, and a decoder; and
the inputting the input text into the text-to-semantic token model comprises:
inputting the input text into the text encoder to obtain a hidden text encoding representation of the input text;
inputting the hidden text encoding representation into the duration predictor to obtain a playback duration, which is predicted by the duration predictor, of the speech corresponding to the input text;
upsampling, by using the upsampling branch, the hidden text encoding representation to a quantity of frames corresponding to the playback duration, to obtain an upsampled hidden text encoding representation; and
decoding the upsampled hidden text encoding representation by using the decoder, to obtain the input semantic token.

16. The computer readable media of claim 13, wherein the semantic token-to-acoustic token model comprises a transformer; and
the inputting the prompt semantic token, the prompt acoustic token, and the input semantic token into the semantic token-to-acoustic token model comprises:
obtaining a prefix by combination in order of the prompt semantic token, the input semantic token, and the prompt acoustic token; and
predicting, using the transformer in a self-recursive manner starting from the prefix, acoustic features of the speech corresponding to the input text at the time points, to obtain the input acoustic token.

17. A system comprising: a processor, and memory storing computer readable instructions that, when executed by the processor, configure the system to perform:
performing feature extraction on a prompt audio to obtain a prompt semantic token and a prompt acoustic token, the prompt semantic token being configured for indicating semantic features of the prompt audio at respective time points, and the prompt acoustic token being configured for indicating acoustic features of the prompt audio at the time points;
performing feature extraction on an input text to obtain an input semantic token, the input semantic token being configured for indicating semantic features of a speech corresponding to the input text at the time points;
generating an input acoustic token based on the prompt semantic token, the prompt acoustic token, and the input semantic token; the input acoustic token being configured for indicating acoustic features of the speech corresponding to the input text at the time points; and
generating an output audio of the input text based on the input acoustic token.

18. The system according to claim 17, wherein the performing feature extraction on the prompt audio comprises:
inputting the prompt audio into a semantic token extractor to generate the prompt semantic token, wherein the semantic token extractor generates the prompt semantic token based on the prompt audio, the semantic token extractor being a machine learning model configured to extract a semantic feature from an audio; and
inputting the prompt audio into an acoustic token extractor to generate the prompt acoustic token, wherein the acoustic token extractor generates the prompt acoustic token based on the prompt audio, the acoustic token extractor being a machine learning model configured to extract an acoustic feature from the audio;
wherein the performing feature extraction on the input text comprises:
inputting the input text into a text-to-semantic token model to generate the input semantic token, wherein the text-to-semantic token model generates the input semantic token based on the input text, the text-to-semantic token model being a machine learning model configured to extract a semantic feature from a text;
wherein the generating the input acoustic token comprises:
inputting the prompt semantic token, the prompt acoustic token, and the input semantic token into a semantic token-to-acoustic token model, to generate the input acoustic token, the semantic token-to-acoustic token model being a machine learning model configured to convert a semantic feature into an acoustic feature; and
wherein generating the output audio comprises:
inputting the input acoustic token into a sound decoder to generate the output audio.

19. The system according to claim 18, wherein the semantic token extractor comprises a convolution branch and a first transformer; and
the inputting the prompt audio into the semantic token extractor comprises:
inputting the prompt audio into the convolution branch to obtain hidden-layer features, which are outputted by the convolution branch, of the prompt audio at the time points;
processing the hidden-layer features of the prompt audio at the time points by using the first transformer, to obtain intermediate-layer features, which are outputted by an intermediate layer of the first transformer, of the prompt audio at the time points; and
clustering the intermediate-layer features of the prompt audio at the time points to obtain the prompt semantic token.

20. The system of claim 18, wherein the text-to-semantic token model comprises a text encoder, a duration predictor, an upsampling branch, and a decoder; and
the inputting the input text into the text-to-semantic token model comprises:
inputting the input text into the text encoder to obtain a hidden text encoding representation of the input text;
inputting the hidden text encoding representation into the duration predictor to obtain a playback duration, which is predicted by the duration predictor, of the speech corresponding to the input text;
upsampling, by using the upsampling branch, the hidden text encoding representation to a quantity of frames corresponding to the playback duration, to obtain an upsampled hidden text encoding representation; and
decoding the upsampled hidden text encoding representation by using the decoder, to obtain the input semantic token.
